(19) United States
(12) Patent Application Publication
(10) Pub. No.: US 2022/0249979 A1
(43) Pub. Date: Aug. 11, 2022

(54) SYSTEMS AND METHODS FOR SOLVENT-FREE LOW PRESSURE EXTRACTION FROM COMPOSITIONS OF MATTER

(71) Applicant: Atlas Bimetals Labs, Inc., Port Townsend, WA (US)

(72) Inventors: Todd Kristian Hansen, Silverdale, WA (US); Richard Dennis Bothell, Sequim, WA (US); Justin Chase Bothell, Port Townsend, WA (US)

(73) Assignee: Atlas Bimetals Labs, Inc., Port Townsend, WA (US)

(21) Appl. No.: 17/661,281

(22) Filed: Apr. 28, 2022

Related U.S. Application Data
(63) Continuation of application No. 17/644,095, filed on Dec. 13, 2021.
Application No. 17/644,095 is a continuation of application No. 17/443,821, filed on Jul. 27, 2021, now abandoned.
(60) Provisional application No. 63/057,195, filed on Jul. 27, 2020.

(51) Int. Cl. B01D 11/02; B01D 5/00

(52) U.S. Cl. CPC B01D 11/0288; B01D 11/0215; B01D 11/0296; B01D 11/0284; B01D 5/0057

(57) ABSTRACT

Systems and methods for solvent-free direct extraction of target compounds from compositions of matter are disclosed herein. The disclosed systems and methods use low pressure to reduce the evaporation temperature of target compounds without affecting the chemical integrity thereof. Target compounds are extracted from the composition of matter in an evacuation chamber and then collected using a capture system. Target compounds may be drawn from the evacuation chamber into the capture system using a carrier gas to facilitate transport of the targeted compounds in the vapor phase. A processed vapor stream may be transported from the capture system back into the evacuation chamber using a recirculation system that includes a blower. The disclosed systems and methods may be used, for example, to extract target compounds from plant matter such as fresh or dried cannabis and hemp, lavender, rosemary, lilac, or other suitable plant matter containing desirable compounds for extraction.

### CROSS-REFERENCE TO RELATED APPLICATIONS

This application is a continuation-in-part of U.S. patent application Ser. No. 17/644,095, filed on Dec. 13, 2021, which is a continuation of U.S. patent application Ser. No. 17/443,821, filed on Jul. 27, 2021, which claims the benefit of U.S. Provisional Patent Application Ser. No. 63/057,195, filed on Jul. 27, 2020, the entireties of which are hereby incorporated herein by reference.

### BACKGROUND

### Field of the Invention

The present disclosure relates to systems and methods for extraction of compounds from compositions of matter.

### Description of the Related Art

Medicinal compounds in plants may be extracted for use in specific applications where the influence of other compounds within the plant is undesirable. Conventional methods of extracting such medicinal compounds use solvents. However, the solvent needs to be removed from the extracted plant medicinal crude oils prior to use of the medicinal compounds. Undesirable trace amounts of solvents invariably remain, and solvent removal techniques may also remove many desirable compounds. Known extraction techniques that do not use solvents are typically limited, and are frequently unable to extract all of the desired compounds or alternatively will extract undesirable compounds along with the compounds of interest. Other extraction techniques require temperatures that are so high that the target medicinal extracts are chemically altered or destroyed.

For example, solvent-based extraction of cannabis and hemp plant matter has numerous limitations. Known extraction methods use one or more solvents to dissolve cannabinoids contained in the plant matter. The methods are significantly more effective when dried cannabis or hemp plant matter is used as a precursor. Logistically, drying may take several days and require a very significant amount of space. Drying also almost always results in a loss of many terpenes. These terpenes are volatile organic compounds that evaporate with water as the plant matter dries. Solvents used include hydrocarbons such as butane or alternatively alcohols. Cannabinoids and the remaining terpenes dissolve in the solvent and are essentially rinsed out of the plant matter with the solvent. The solvent may subsequently be removed using vacuum. At least a small amount of solvent invariably remains after the initial vacuum removal thereof, and high temperature processing is often required to remove the residual solvent. This is particularly the case when alcohol solvents are used, on account of the typically higher boiling points of alcohols as compared to comparable molecular weight hydrocarbons. Moreover, the solvents typically used are highly flammable, and thus arduous engineering and safety processes must be implemented. Use of alcohol solvents also leads to the extraction of chlorophyll, an undesirable contaminant in many extracts.

Alternatively, supercritical carbon dioxide (CO₂) may be used as a solvent for extraction. However, this method requires plant matter to be dried and ground into a fine powder prior to extraction. In addition, supercritical CO₂ processes frequently result in the degradation of terpenes. Thus, the use of supercritical CO₂ is suboptimal for extraction where the target compounds include terpenes that may be degraded by the use thereof. In addition, supercritical CO₂ processes require the use of equipment capable of withstanding very high pressures, which increases both costs and risks to safety. In addition, the high pressure required limits in practice the diameter of extraction equipment, and thereby limits batch volume.

Steam distillation is a common industrial extraction technique. It is not however commonly used in the cannabis industry because it does not remove cannabinoids efficiently. Steam distillation uses high temperature steam to infuse plant matter and carry the target compounds out of the plant matter to a condenser. Vacuum is not used in this technique and the high temperatures alter the quality of the extracts.

Vacuum is used industrially for distillation but is generally limited in scope to purification of oils that have already been extracted. Vacuum is typically not used to extract crude oils or target compounds directly from plant matter.

For example, short path distillation techniques are commonly used to separate one compound from a crude oil mixture containing two or more oils. Conventional short path techniques use an evenly heated crude mixture which is often a spinning flask in a bath of heated water or oil. This is known as a rotary evaporator. The flask is evacuated and the evaporated compounds are vacuum pumped to a condenser section of the apparatus. The condenser is also temperature controlled so as to select one compound from the vapor stream by differential condensation.

Another variant of the short path distillation technique employs vacuum and a heated spinning disc. The disc is heated in vacuum and spun so that it centrifugally spreads oils. The low aspect ratio of precisely heated oils facilitates evaporation of target distillates which condense on a cold plate positioned near the rotating disc. The remaining compounds are wiped from the disc at the circumference. There are other variants of these forms of vacuum distillation, but all use pre-extracted crude mixtures as a precursor. These techniques do not extract crude mixtures directly from plant matter.

U.S. Patent Application Publication No. 2019/0299115 discloses a solvent-free method of extracting phytochemicals from plant matter that uses vacuum. Ahmad, et al. disclose a solvent-free method of extracting essential oils from plant matter. Ahmad, M. S., et al. “Novel Closed System Extraction of Essential Oil: Impact on Yield and Physical Characterization,” Int'l Conf Biotechnol. Environ. Manag., 2014, 75, 42-46. U.S. Patent Application Publication No. 2004/0147767 discloses a method of extracting compounds from plant matter using heated gas. U.S. Patent Application Publication No. 2019/0366231 discloses a solvent-free method of extracting oils from plant matter that uses a centrifugal electrostatic precipitator. Each of these methods have limitations that may limit the utility thereof.

Thus, there remains a need for a solvent-free system and method of extraction that is capable of extracting target medicinal compounds from plants that does not alter the target compounds or contaminate the target compounds with undesirable byproducts.

### SUMMARY

Systems and methods for solvent-free direct extraction of target compounds from compositions of matter are disclosed herein. The disclosed systems and methods use low pressure to reduce the evaporation temperature of target compounds without affecting the chemical integrity thereof. Target compounds are extracted in an evacuation chamber from a composition of matter composed of two or more compounds, and the extracted target compounds are then dispersed within the system from one location to another and may be collected using a capture system. Target compounds may be drawn from the evacuation chamber into the capture system using a carrier gas to facilitate transport of the target compounds in the vapor phase. The carrier gas may be air, nitrogen, one or more other gases, or a combination thereof, or may alternatively be a gas present within the system that is not separately introduced. The evaporated target compounds may, for example, be drawn into the capture system using a recirculation system that includes a blower. In some embodiments, the composition of matter is plant matter. The disclosed systems and methods may be used, for example, to extract target compounds from plant matter such as fresh or dried cannabis and hemp, lavender, rosemary, lilac, or other suitable plant matter containing desirable compounds for extraction.

Target compounds are extracted from a composition of matter such as plant matter by subjecting the composition of matter to vacuum and, optionally, applying heat. The target compounds are vaporized within an evacuation chamber, and are then transported as a vapor stream into a capture system. Target compounds are condensed from the vapor stream within the capture system. The capture system may preferably have at least two stages. The capture system may preferably include one or more condensers. The composition of matter may optionally be gently heated under vacuum to further facilitate extraction. A recirculation system may optionally be used to facilitate transport of the target compounds within the system.

In some embodiments, the composition of matter is plant matter. The plant matter may be fresh plant matter that is not pre-dried or frozen prior to extraction. The plant matter may optionally be mechanically lysed prior to or during extraction. Lysing the product prior to or during processing may facilitate extraction of a higher percentage of the desired product(s), and may reduce the extraction time required to process the plant matter. In addition, lysing the plant matter may also increase the density of the plant matter loaded into the system at a given time, thereby enhancing process efficiency.

In some embodiments, target compounds from a composition of matter may be vaporized within an evacuation chamber, optionally applying heat and/or vacuum, and transported as a vapor stream into a chamber where vapor deposition may occur.

Each of the foregoing and various aspects, together with those set forth below and summarized above or otherwise disclosed herein, including the figures, may be combined without limitation to form claims for a device, apparatus, system, method of manufacture, and/or method of use.

### BRIEF DESCRIPTION OF THE DRAWINGS

FIG. 1 shows a schematic representation of a first embodiment of the disclosed system.

FIG. 2 shows an exploded view of a schematic representation of the evacuation chamber of the embodiment shown in FIG. 1.

FIG. 3 shows an exploded view of a schematic representation of the capture system of the embodiment shown in FIG. 1.

FIG. 4 shows an exploded view of a schematic representation of a blower chamber that forms part of the recirculation system of the embodiment shown in FIG. 1.

FIG. 5 shows an exploded view of a schematic representation of a heat exchange chamber that forms part of the recirculation system of the embodiment shown in FIG. 1.

FIG. 6 shows a schematic representation of a second embodiment of the disclosed system.

FIG. 7A shows an exploded view of a schematic representation of the evacuation chamber of the embodiment shown in FIG. 6.

FIGS. 7B-7D show schematic representations of alternate embodiments of the evacuation chamber shown in FIG. 7A with blowers situated at various locations within the respective evacuation chambers to increase the circulation of gases.

FIG. 8 shows a schematic representation of another alternate embodiment of the evacuation chamber with three product holding chambers.

FIG. 9A shows a schematic representation of another alternate embodiment of the evacuation chamber with a rotating drum to assist with stirring of the product in the product holding chamber.

FIG. 9B shows a schematic representation of another alternate embodiment of the evacuation chamber with a rotating auger to assist with stirring of the product in the product holding chamber.

FIG. 9C shows a schematic representation of another alternate embodiment of the evacuation chamber with a fluidized bed and blower to assist with stirring of the product in the product holding chamber.

FIG. 10 shows a schematic representation of another alternate embodiment of the evacuation chamber with a lyser to assist with lysing of the product in the product holding chamber.

FIG. 11A shows an exploded view of a schematic representation of the third secondary condenser of the embodiment shown in FIG. 6.

FIGS. 11B-11D show schematic representations of alternate embodiments of the condenser shown in FIG. 11A with blowers situated at various locations within the respective condensers.

FIG. 12A shows an exploded view of a schematic representation of the fourth secondary condenser of the embodiment shown in FIG. 6.

FIGS. 12B-12D show schematic representations of alternate embodiments of the condenser shown in FIG. 11A with blowers situated at various locations within the respective condensers.

FIGS. 13A-13C show schematic representations of alternate embodiments of the condenser shown in FIG. 11A with inlet valves and outlet valves to regulate the flow of the vapor stream into and/or out of the respective condensers.

FIG. 14 shows a schematic representation of an embodiment of a capture system that includes an array of condensers.

FIG. 15A shows a schematic representation of an alternate embodiment of the condenser shown in FIG. 11A with a wiper system.

FIG. 16B shows a three-dimensional cutout view of the embodiment shown in FIG. 15A.

FIG. 16 shows a schematic representation of an alternate embodiment of the condenser shown in FIG. 11A with an auger-shaped flow path.

FIG. 17 shows a schematic representation of a third embodiment of the disclosed system.

FIG. 18 shows an alternate embodiment of the embodiment shown in FIG. 17 that has insulation surrounding all parts of the system except the second product capture vessel.

FIG. 19 shows an alternate embodiment of the embodiment shown in FIG. 17 that has insulation surrounding all parts of the system, including the second product capture vessel.

FIG. 20 shows an alternate embodiment of the embodiment shown in FIG. 18 that has an outer enclosure that is connected to an inert gas port.

FIG. 21 shows an alternate embodiment of the embodiment shown in FIG. 19 that has an outer enclosure that is connected to an inert gas port.

FIG. 22 shows a three-dimensional representation of the embodiment shown in FIG. 17.

FIG. 23 shows an opposing view of the three-dimensional representation of the embodiment that is shown in FIG. 22.

FIG. 24A shows a cross-sectional view of the three-dimensional representation of the embodiment shown in FIGS. 22-23.

FIG. 24B shows an exploded view of a part of the cross-sectional view shown in FIG. 24A.

FIG. 25A shows another cross-sectional view of the three-dimensional representation of the embodiment shown in FIGS. 22-23.

FIG. 25B shows an exploded view of a part of the cross-sectional view shown in FIG. 25A.

FIG. 25C shows an exploded view of a part of the cross-sectional view shown in FIG. 25A.

FIG. 25D shows an exploded view of a part of the cross-sectional view shown in FIG. 25A.

### DETAILED DESCRIPTION OF THE ILLUSTRATED EMBODIMENTS

Systems and methods for solvent-free direct extraction of target compounds from compositions of matter are disclosed herein. The disclosed systems and methods use low pressure to reduce the evaporation temperature of target compounds without affecting the chemical integrity thereof. Target compounds are extracted in an evacuation chamber from a composition of matter composed of two or more compounds, and the extracted target compounds are then dispersed within the system from one location to another and may be collected using a capture system. Target compounds may be drawn from the evacuation chamber into the capture system using a carrier gas to facilitate transport of the target compounds in the vapor phase. The carrier gas may be air, nitrogen, one or more other gases, or a combination thereof, or may alternatively be a gas present within the system that is not separately introduced. The evaporated target compounds may, for example, be drawn into the capture system using a recirculation system that includes a blower. In some embodiments, the composition of matter is plant matter. The disclosed systems and methods may be used, for example, to extract target compounds from plant matter such as fresh or dried cannabis and hemp, lavender, rosemary, lilac, or other suitable plant matter containing desirable compounds for extraction.

Target compounds are extracted from a composition of matter such as plant matter by subjecting the composition of matter to vacuum and, optionally, applying heat. The target compounds are vaporized within an evacuation chamber, and are then transported as a vapor stream into a capture system. Target compounds are condensed from the vapor stream within the capture system. The capture system may preferably have at least two stages. The capture system may preferably include one or more condensers. The composition of matter may optionally be gently heated under vacuum to further facilitate extraction. A recirculation system may optionally be used to facilitate transport of the target compounds within the system.

In some embodiments, the composition of matter is plant matter. The plant matter may be fresh plant matter that is not pre-dried or frozen prior to extraction. The plant matter may optionally be mechanically lysed prior to or during extraction. Lysing the product prior to or during processing may facilitate extraction of a higher percentage of the desired product(s), and may reduce the extraction time required to process the plant matter. In addition, lysing the plant matter may also increase the density of the plant matter loaded into the system at a given time, thereby enhancing process efficiency.

In some embodiments, target compounds from a composition of matter may be vaporized within an evacuation chamber, optionally applying heat and/or vacuum, and transported as a vapor stream into a chamber where vapor deposition may occur.

In some embodiments, the composition of matter may be introduced as part of a mixture such as, for example, a slurry. The mixture may be water-based or may be based on another liquid, and may be introduced with the composition of matter prior to processing or alternatively during processing. The liquid may be introduced during the lysing stage described above or alternatively prior to the lysing stage. In some embodiments, the mixture is raw plant material combined with a liquid such as, for example, water.

In some embodiments, raw plant matter forms a slurry following lysing without introduction of a separate liquid.

In some preferred embodiments, plant matter may be fresh cannabis or hemp that is not pre-dried. In such embodiments, the plant matter may be heated under vacuum to one or more temperatures between about 50-200° C., preferably between about 140-190° C., more preferably between about 150-185° C., and even more preferably between about 170-180° C. The vacuum may be between about 0.001-100 torr, preferably between about 0.01-20 torr, and more preferably between about 0.1-10 torr. The target compounds may include cannabinoids and terpenes. The target compounds may be transported from the evacuation chamber to the capture system by diffusion or optionally by drawing the target compounds into the capture system using a blower. The blower may preferably be part of a recirculation system. An appreciable amount of the vaporized target compounds will condense within the capture system and will accumulate as one or more condensates. The condensates may include a full spectrum of cannabinoid and terpene crude oil extracts that are not contaminated by solvents. Specific target compounds may be isolated if a capture system with multiple condensers maintained at different temperatures is used. The total amount of target compounds that will condense within the capture system and where various fractions will condense within the capture system may be fine-tuned as described below. The fine-tuning also minimizes the amount of undesirable compounds, such as chlorophyll and waxes, within the condensates, and these amounts will preferably be negligible.

When used to extract target compounds from plant matter, the disclosed systems and methods allow more efficient processing and yield extracts that are more pure and contain more desirable compounds and fewer undesirable compounds compared to previously disclosed systems and methods for extraction of compounds from plant matter.

### Evacuation Chamber

Target compounds are extracted from the composition of matter in an evacuation chamber. In some embodiments, the composition of matter is plant matter. The evacuation chamber may include a raw material enclosure and, optionally, a heating system. The evacuation chamber is connected to a vacuum pump.

The vacuum pump may be connected to the evacuation chamber through a valve, such that the pressure within the evacuation chamber and other parts of the system may be controlled.

In some embodiments, the raw material enclosure is configured to receive a composition of matter, such as raw plant matter, for processing within the system. The raw material enclosure may be a basket, such as a mesh basket, or may be composed of a plurality of baskets, such as a plurality of mesh baskets. In some embodiments, the mesh basket(s) are breathable. In some embodiments, the raw material enclosure is composed of a plurality of baskets that are stackable. In some embodiments, the raw material enclosure is capable of retaining wet lysed plant matter or a slurry containing plant matter.

In some preferred embodiments, the longest dimension of the raw material enclosure will be less than the longest dimension of the evacuation chamber. The evacuation chamber may include a housing, and the raw material enclosure may be held in a position where it does not directly contact the housing. The raw material enclosure may, for example, be held in its position by brackets or other similar securing components. This allows for improved circulation of vapors released from the composition of matter, such as plant matter, held in the raw material enclosure during processing. The raw material enclosure may include or be surrounded by a mesh screen that allows vapor to readily pass through the basket into the other parts of the evacuation chamber and then outflow into the capture system.

The raw material enclosure may be removable to facilitate the loading and unloading of a composition of matter, such as plant matter, and cleaning of the enclosure.

In some embodiments, a composition of matter, such as plant matter, may be heated under vacuum in the evacuation chamber using a heating system. The heating system may be part of the raw material enclosure, may be partially part of the raw material enclosure and partially composed of separate components, or may be entirely composed of components that are separate from the raw material enclosure.

The heating system may be configured to progressively heat the composition of matter. In some embodiments, the composition of matter is plant matter. As the plant matter is heated, various target compounds will vaporize and may be condensed using the capture system in the order in which they are volatilized. This further enhances separation between target compounds. For example, for extraction of target compounds from cannabis or hemp plant matter, the plant matter may be ultimately heated under vacuum to a temperature of between about 50-200° C., preferably between about 140-190° C., more preferably between about 150-185° C., and even more preferably between about 170-180° C.

The heating system may be used with or without a recirculation system. If a recirculation system is used in conjunction with a heating system, the carrier gas used in the recirculation system may also act as a heat source, where a pre-heated carrier gas transfers heat to the plant matter.

The heating system may include a plurality of heating stages. In some embodiments, a first heating element may be configured to apply heat to the external parts of the evacuation chamber and a second heating element may be configured to apply heat to the composition of matter. The first heating element may preferably cause the external parts of the evacuation chamber to be heated to a higher temperature than the composition of matter. This prevents volatilized compounds within the vapor stream from condensing within the evacuation chamber, and thus facilitates transport of the target compounds in the vapor phase to the capture system as a vapor stream.

The heating elements may preferably be capable of independent operation, such that a specific heating element may be activated before or after another heating element. This will allow parts of the evacuation chamber to reach a desired temperature before other parts are heated. For example, the external parts of the evacuation chamber may first be heated to a specified temperature before a second heating element is activated to heat the plant matter. While some heat transfer to the composition of matter may occur via convection or even conduction, the primary source of heat for the composition of matter will be via heat applied through the second heating element. Thus the composition of matter will not reach a sufficiently high temperature before the external parts of the evacuation chamber are heated to the desired temperature so as to result in undesirable condensation of volatilized compounds from the composition of matter.

The second heating element may be a standard induction or resistance heating element or may alternatively be a microwave system. The heating element may partially intrude into the raw material enclosure described above. The heating element may be composed of one or more heaters, and the heaters may be connected to one another by one or more heat transfer bridges to facilitate heat transfer to the composition of matter, such as raw plant matter, and avoid overheating the composition of matter. One or more temperature probes may be used to monitor the one or more heaters.

Conductive bridge material(s) may be used to interconnect the heater elements to each other and to temperature monitoring probes, thereby allowing more stable and consistent heating inside the evaporation chamber and other parts of the system. Energy added to the system will flow across the material bridge, thus allowing for more uniform temperature gradients between the heaters and increasing the surface area contact between the heating system and the composition of matter.

### Recirculation

In some embodiments, one or more recirculation components are used to facilitate transport of target compounds into the capture system, to facilitate circulation of vapors within the capture system to improve system efficiency, and/or as part of a recirculation system that facilitates transport of a processed vapor stream from the capture system to the evacuation chamber. In some embodiments, at least some of the recirculation components form a recirculation system that is separate from the capture system.

Use of recirculation components within the capture system may increase the yield of target compounds and may also increase the rate of condensation of target compounds within the capture system. Use of recirculation components at specific locations within the disclosed systems for direct extraction will increase the mass transfer rate from the composition of matter to the capture system.

The recirculation components may include one or more blowers proximate to the evacuated plant matter. The one or more blowers are used to direct a vapor stream that includes a carrier gas and may also include a small amount of target compounds, as described below, into the capture system, within the capture system, and/or from the capture system to the evacuation chamber. The vapor stream that includes the carrier gas will become saturated or partially saturated with target compounds in the evacuation chamber. The saturated or partially saturated vapor stream will exit the evacuation chamber via an outlet and flow toward the capture system. The flow rate and composition of the carrier gas will determine, at least in part, the extent to which the carrier gas will be saturated by target compounds before it is transported into the capture system.

In some embodiments, the carrier gas may be air. In other embodiments, the carrier gas may be an inert gas such as nitrogen or argon. In yet other embodiments, the carrier gas may be a gas that causes a specific desirable reaction to occur within the system, where the carrier gas may be a reactant or a catalyst. In yet other embodiments, the carrier gas may be composed primarily of the vapor stream generated by reducing the pressure within and/or heating the composition of matter held within the evacuation chamber.

For embodiments where the composition of matter is plant matter, it has been determined that higher flow rates help reduce the production of unwanted byproducts generated via excessive heat exposure of the plant matter and thereby increase the collection rate of the desired condensed products.

The blowers may be housed within the evacuation chamber, within the capture system, and/or within the recirculation system. In some embodiments, one or more blowers within the capture system are housed within blower chambers. In some embodiments, one or more blowers within the recirculation system are housed within blower chambers. The blower chambers may be positioned at various locations within the system, such as between the outlet from the evacuation chamber and an inlet into the capture system, within the capture system, or within a recirculation system that the vapor stream enters upon exiting an outlet from the capture system and before entering an inlet into the evacuation chamber. Multiple blowers positioned at different locations within the disclosed system may be used. Each blower chamber may house one or more blowers.

The evacuation chamber, capture system, and/or recirculation system may include one or more blower enclosures. Each blower enclosure houses one or more blowers or fans. In some embodiments, the blower enclosure may be a part of the blower chamber. In other embodiments, the blower enclosure is the blower chamber.

The blower enclosure may be connected to one or more inflow and outflow components, and may further include irrigation channels or other mechanical features that facilitate collection of products. The inflow component may be a port that allows inflow from the blower enclosure. A vacuum pressure sensor may be positioned at or proximal to the inflow port. The outflow component may be a port that allows outflow from a recirculation chamber within the capture system toward one or more condensers. The outflow port may be situated on the top side or bottom side of the blower enclosure, or may alternatively be transversely mounted on the side of the blower enclosure. In some preferred embodiments, the outflow port may be situated on the bottom side of the blower enclosure.

The blower enclosure may also include a heating element and/or a cooling element. The one or more blowers or fans housed within a blower enclosure may have blades with a heating element. Alternately, one or more blowers or fans not housed within a blower enclosure may have blades with a heating element. Heating elements on the blades of the blowers or fans assist in preventing condensation on the blades that may then cause the blower or fan to seize.

The blowers may preferably be mounted within the system to generate a vertical flow path when the system is in use. The vertical flow path may, for example, protect the blower from build-up of condensates thereupon by facilitating the gravity drip of condensates off the blower. Such condensates may be collected in a separate area. For example, the blower enclosure may include a void underneath each of the one or more blowers, where condensates that drip off the blower are collected in the void. The void may have a sloped configuration or may include irrigation channels to direct the collected condensates into a collection area or enclosure. This collection area or enclosure may be the same collection area or enclosure where other condensates are collected or may alternatively be a separate area or enclosure.

The blowers may be controlled by a microcontroller, as described below, or may automatically be activated upon activation of the system.

When the carrier gas and the target compounds contained therein enter the capture system, a significant percentage of the target compounds will be condensed by one or more condensers to form condensates, as described in more detail below. Following condensation, the carrier gas will contain a significantly smaller quantity of target compounds. In some embodiments, this unsaturated carrier gas is recirculated and reintroduced into the evaporation chamber via a recirculation system.

Because the carrier gas is substantially unsaturated when it is reintroduced into the evaporation chamber, more target compounds are volatilized and re-saturate the carrier gas stream. The saturated carrier gas then reenters the capture system, where condensation of the target compounds occurs. This process may be repeated several times to maximize the yield of target compounds. The carrier gas may also function as a gas sweep that removes the target compounds by transporting them out of the evaporation chamber and into the capture system.

It has been determined that recirculation of the carrier gas significantly increases the rate of mass transfer. As the mass transfer rate is already high under vacuum compared to atmospheric pressure, it would not be expected that use of a carrier gas would provide further improvement in the mass transfer rate. Rather, introduction of a carrier gas will increase the pressure, and would thus be expected to reduce the mass transfer rate. In addition, a forced gas recirculation convection system is typically more effective at high pressures, such as pressures at or above atmospheric pressure. See, e.g., U.S. Patent Application Publication No. 2004/0147767.

### Capture System

In some preferred embodiments, the capture system is a cooling system. The capture system may preferably include one or more condensers. In some preferred embodiments, multiple condensers may be used. The condensers may be positioned in the vapor flow path, where each successive downstream condenser may be held at a lower temperature than the adjacent upstream condenser. The least volatile target compounds will condense at the condenser that is furthest upstream. Each successive downstream condenser will condense more volatile compounds. As the vapor flow progresses downstream toward the lower temperature condensers, the most volatile target compounds will begin to condense. As a result, the target compounds collected at each condenser will be fractionated by volatility. Each fraction will condense at the first condenser that has a temperature at or below the condensation temperature of that fraction under the conditions of the system. Compounds within the vapor stream that condense at temperatures below that of the target condenser will remain in vapor form and will not condense at the target condenser.

In some embodiments, the capture system may preferably include at least two condensers. Each condenser may be composed of a tube configured to allow the vapor stream to flow there-through and other components or features that facilitate collection of a specific fraction. The tube may include one or more ports that allow the connection of additional lines to the condenser tube to facilitate heating, cooling, and temperature control. In some embodiments, the tube may itself be a condenser. In some embodiments, the condenser tube may be composed of a metal or metal alloy, such as titanium or stainless steel. Multiple condensers may be connected serially, such that the vapor stream passes through the next condenser in the series after having passed through the previous condenser in the series. A condenser may include, for example, one or more irrigation channels or other mechanical features or components such that a fraction that is collected at the condenser will drip or flow through the irrigation channels or other mechanical features or components. A condenser may further include or be coupled to one or more product capture or storage enclosures to retain the fraction that is collected at the condenser.

In embodiments where the tube itself is a condenser, condensed product may drip directly from the tube and may bypass the remaining successive condensers. The condensed product may be deposited or may drain directly into an irrigation channel, or alternatively may be deposited into a product capture or storage enclosure. In other alternative embodiments, the condensed product may pass through additional condensers before it is deposited in or drains into an irrigation channel or product capture or storage enclosure.

In some embodiments, one or more condensers include a cooled condenser body that is configured to increase condensation of the target fraction intended for condensation at that condenser. For example, the cooled condenser body may be cooled to a temperature below the freezing temperature of water. In such embodiments, ice may form on the surface of the cooled condenser body. This forms a barrier layer and prevents further condensation on the surface of the cooled condenser body. Target fractions will then condense on the surface of the ice and thereafter may be readily removed therefrom and collected in one or more product capture enclosures located further downstream within the capture system and below the cooled condenser body. The one or more product capture enclosures may include a fluid medium to facilitate product transfer.

In some alternate embodiments, a water condensation condenser may be used to remove water from the vapor stream that is transported through the capture system.

In some embodiments, the condensers may be jacketed, where the jackets allow fluid to flow therein and where the fluid flowing within the jacket is used to cool or heat the condensers. The condensers may be coupled to temperature sensors and/or thermostat controls for data acquisition and temperature control. In some embodiments, the temperature sensors are thermocouples.

The capture system may further include one or more vapor flow directors to direct the vapor stream toward one or more cooled surfaces of the targeted cooled condenser body. Flow directors may allow fractions within the vapor stream that are not targeted by a specific condenser to drip or flow past the condenser, while fractions that are targeted by the condenser will be directed toward the cooled condenser body or other desired areas within the capture system.

For example, with respect to the extraction of cannabinoids and terpenes from cannabis or hemp plant matter, specific cannabinoids and terpenes will be selectively removed from the vapor stream within specific condensation zones within the capture system. For example, cannabinoids may be selectively removed under vacuum in a primary condenser at an elevated temperature of 40-60° C., leaving more volatile terpenes and water to pass through in the vapor phase; water vapor may then be captured in a secondary condenser operating at just below 0° C., and one or more additional condensers operating at lower temperatures may capture the lighter volatiles. A similar process may be used in stages to isolate various cannabinoids. However, cannabinoids typically have vapor points in overlapping ranges, and will thus form a variety of mixtures depending on the operating temperatures of the various collection stages.

In some embodiments, the disclosed systems use a relatively high vacuum (low system pressure). Using a higher vacuum (lower system pressure) may reduce the amount of unwanted byproducts generated either by reaction or decomposition due to heat exposure.

In some embodiments, the disclosed systems use a relatively low vacuum (high system pressure) as compared to prior art extraction systems, which allows capture of a wider range of target compounds. In addition, by using a relatively low vacuum (i.e., a relatively high pressure), a larger quantity of target compounds may be transported in the vapor stream.

In some embodiments, the system may further comprise one or more valves or gates to direct the flow of the vapor stream toward specific condensers within the capture system. The valves or gates may be selectively actuated to cause the vapor stream to remain in the area of a specific condenser for a specified period of time that maximizes condensation of the target compounds for that condenser without condensing other compounds that are not targeted for condensation at that condenser. For example, target compounds that condense at relatively high temperatures may be more thoroughly removed from the vapor stream by preventing the vapor stream from flowing toward lower temperature downstream condensers by closing appropriate valves or gates until the target compounds for the higher temperature condensers have been substantially removed from the vapor stream. The vapor stream may be recirculated to flow over the higher temperature condensers until the desired amount of target compounds have been condensed. This may be accomplished using recirculation ducts that force the vapor stream to flow over the higher temperature condensers multiple times until the valve or gate that prevents flow toward the lower temperature condensers is opened. A valve or gate may then close the recirculation duct to force the vapor stream to flow toward the next lower temperature condenser. By using valves or gates and recirculation ducts for each successively lower temperature condenser, the condensation of target compounds at each condenser may be optimized.

In some alternate embodiments, a single condenser that includes a variable heater may be used. The condenser is held at a temperature that is sufficiently low to condense substantially all of the target compounds. The condenser is then slowly heated to release comparatively more volatile target compounds as these compounds liquefy, for example, as oils with progressively lower viscosity with increased application of heat. As the condenser is slowly heated, distinct fractions of liquefied compounds, such as oils, will flow off the condenser for separation. More viscous oils will require higher temperatures to flow, and thus by gradually heating the condenser distinct fractions of target compounds may be separated.

Such multi-stage product delivery systems are operated by raising the temperature incrementally and allowing condensation to occur in a single condensation area. Isolated products from each temperature increment may then be delivered to a specific product capture or storage enclosure by irrigation. Products that are isolated at different temperatures are directed to different product capture or storage enclosures.

The disclosed systems may allow a target condenser to be held at temperatures that are not substantially below the condensation temperature of the target compounds for that condenser. For example, it may be sufficient to hold the target condenser at a temperature that is approximately 5° C. lower than the condensation temperature of the target compounds for that condenser. This enhances separation between the various target compound fractions. Heat may be dissipated using cooling fans, which may obviate the need for a refrigeration system as a component of the capture system.

In addition, the capture system may include recirculation components such as blowers that may be used to recirculate the vapor stream within specific areas of the capture system. The capture system may be integrated with the recirculation system such that components of the recirculation system, or the entire recirculation system, form part of the capture system. Thus, the recirculation system may be used not only to facilitate transport of the processed vapor stream from the capture system back into the evacuation chamber but also to facilitate both transfer and recovery of target compounds within the capture system. Further, recirculation components may be used to facilitate transfer of the unprocessed vapor stream from the evacuation chamber into the capture system.

The one or more condensers may further include or be operationally connected to a heating system to facilitate re-liquification of fractions that are condensed after processing is complete. This will facilitate removal of fractions from the condensers and prevent issues such as gelling or solidification of a fraction from hindering its collection. The heating system may be part of a single heat exchanger that is capable of both heating and cooling the condenser. A liquid fraction may be transferred from a condenser to one or more product capture enclosures through one or more irrigation channels or other mechanical features or components of the condenser. In some embodiments, the product capture enclosures may, for example, be threaded jars or other similar containers. A valve may separate the condenser from the one or more product capture enclosures. One or more blowers coupled to the condenser may further facilitate recovery of the desired fraction. In addition, the heating system that is part of or coupled to a condenser may be used to facilitate further flow of the vapor stream through the capture system upon the completion of a specific processing step or collection of a specific fraction.

The system may be returned to atmospheric pressure prior to application of heat to the condensers, thereby minimizing re-volatilization of fractionated products.

To prevent undesired condensation of fraction before various parts of the system have attained desired target temperatures, heating or cooling elements within the capture system may be activated in conjunction with the heating system of the evacuation chamber, and valves or gates between the evacuation chamber and capture system and between various condensers or other elements of the capture system may be opened or closed as desired. This will allow various components of the system to achieve desired target temperatures to facilitate optimal performance for the collection of target compounds. This may be particularly important, for example, when collecting certain oil-based products or fractions.

### Wiper System

The viscosity of target compounds may be temperature dependent. Thus, in some embodiments, a wiper system may be used to direct viscous target compounds away from the condenser, either to collect such viscous target compounds upon completion of the process or such that additional target compounds may be more readily condensed after the viscous target compounds have been collected. In some embodiments, the wiper system is a mechanical wiper system.

### Fluid-Like Transfer Medium

In some embodiments, a fluid-like transfer medium may be used to enhance the heat transfer rate in a designated part of the system. Since vapor density is reduced in vacuum, the convective capacity of the rarified gas for heat transfer is reduced. By including a fluid-like medium such as sand or metallic beads in the evacuation chamber, the heat transfer rate to the composition of matter, such as plant matter, may be increased. The fluid-like medium may increase conductive contact and may also allow mixing of the composition of matter in the fluid-like medium to further enhance heat transfer.

In some alternate embodiments, a fluidized bed may be used. The composition of matter, such as plant matter, may be mixed with the solid material of the bed and the mixture may be fluidized using a highly diffuse hot gas stream applied into the mixture or by agitation of the mixture such as by tumbling. This enhances conductive heat transfer and also removes target compounds as part of a vapor stream that flows through the fluidized bed.

### Plant Matter Preparation

In embodiments where the composition of matter is plant matter, the plant matter may be lysed prior to volatilization. The lysing may preferably be performed under vacuum. In some embodiments, the lysing may preferably be performed using a blender or grinder. The plant matter may thus form a slurry, which offers superior heat transfer properties.

In some embodiments, the slurry may be placed in one or more basins within the evacuation chamber. The basins may be rotated or stirred to increase thermal transfer and thereby increase the evaporation rates of target compounds. The slurry may be heated within the one or more basins using one or more heaters such as resistive heaters.

In some alternate embodiments, a rotating head drum may agitate the slurry as it dries.

In other alternate embodiments, a heated evacuated tube and auger may be used to stir the slurry as it dries and longitudinally purge the slurry with the carrier gas.

In yet other alternate embodiments, the slurry may be placed in a finely meshed basket and spun at high velocity to remove water and oils using centrifugal forces. In such embodiments, the basket may optionally be heated while it is spun. Spinning of the basket allows mechanical removal of water and oils from the slurry both quickly and with little evaporative energy expenditure. The oils may then be extracted from the liquid mixture using the extraction techniques disclosed herein. The slurry may be frozen and stored without degradation for an indefinite period, for example until such time as extraction equipment is available.

Other compositions of matter may be prepared in similar ways using similar system components and methods.

### Plant Matter Processing

In embodiments where the composition of matter is plant matter, once adequate heat and vacuum are applied to a slurry of freshly lysed plant matter, the slurry will boil. This will remove excess water and some terpenes. In some preferred embodiments, the slurry will be heated to approximately 65-75° C. at approximately 200-250 torr, more preferably to 70° C. at approximately 230-235 torr. Numerous other temperatures and pressures may alternatively be used.

The capture system may include multiple condensers held at temperatures lower than the temperature of the heated slurry. Water is removed from the system by condensing it as a liquid, and optionally freezing it thereafter, rather than removing it as water vapor. This allows use of a smaller vacuum pump than would be required if water was removed as water vapor. For the processing of cannabis or hemp plant matter, most cannabinoids are not removed at this step, as they require higher temperatures or higher vacuum to evaporate. High vacuum is impossible to achieve until most of the water is removed from the system due to its high vapor pressure.

In embodiments that include multiple condensers, it has been found that the system operates highly efficiently if the first condenser is held at approximately 20° C. This lowers the saturated water vapor pressure at the condenser to approximately 17-18 torr. If the slurry is heated to 70° C. at approximately 230-235 torr as described above, approximately 214-217 torr of water vapor will be removed at this condenser. This is an approximately 91-95% reduction of water vapor, which is highly efficient for a system that does not require mechanical pumping or refrigeration. The water and terpene condensate mixture may simply be removed from the vacuum system with a peristaltic pump or similar water pump when the water accumulation merits draining. The terpenes are insoluble in water and less dense, and thus form a layer on the top of the water that may easily be removed.

Once the vapor stream flows past the first condenser, it is then directed toward one or more condensers that are held at lower temperatures. The temperature of these subsequent condensers may be as low as cryogenic temperatures (<−150° C.). In some embodiments, the next lower temperature condenser is held at slightly above the freezing point of water under the conditions so that the remaining water can be removed as a liquid. If a −15° C. condenser is used this will remove another 92% of the remaining water vapor. The use of multiple condensers allows for over 99% of the water to be removed from the system as a liquid without requiring mechanical vacuum pumping and allows for nearly all terpenes to be collected.

It has been found that using lower temperature (−60° C.) and cryogenic (liquid nitrogen) temperature condensers further downstream allows for extraction of nearly all the terpenes from the vapor stream. This is particularly useful once most of the water vapor has been removed using higher temperature upstream condensers. It has been found that the terpenes will emulsify if a significant amount of water is present at the cryogenic condensers.

After most of the water is removed from the slurry the temperature of the remaining product may be increased up to the ideal extraction temperature, which is approximately 150-200° C. for cannabinoids. The vacuum may also be increased to approximately 5 torr.

Other compositions of matter, including other types of plant matter and non-plant matter compositions of matter, may be processed in similar ways using similar methods.

### Microcontroller

In some preferred embodiments, a microcontroller may be used to control process variables such as vacuum pressure, heating system temperatures, the temperature of the condensers, the recirculating blowers, the vacuum pump and various water pumps, wipers, and level sensors. Further, the microcontroller may be accessed via a user interface on a computer or smartphone. The user interface may preferably provide information regarding system parameters and error notification.

The microcontroller allows monitoring of the process variables so as to optimize the process for each phase. For example, since wet plant matter will only allow a specific vacuum pressure to be obtained based on the vapor pressure of the plant matter, it is possible to determine when the plant matter has dried. The microcontroller may therefore reliably detect this point and add a more measured quantity of heat to be applied to the plant matter to avoid overheating.

The microcontroller may also be used to determine when processing of the composition of matter, such as raw plant matter, is complete. For example, observed changes in time between pressure and temperature fluctuations and/or observed changes in heater cycling intervals in relation to time may be used to determine when processing is complete. Fluctuation of heat loss from evaporation is one of the mitigating factors in causing the change in duration between heat input cycles as processing of the composition of matter occurs.

The microcontroller may be used to regulate heating intervals of the various heating elements. Pulsing heaters on and off for short periods may be beneficial to avoid overheating the composition of matter and to allow for temperature probes to properly acclimate with the actual heat in the system so that they properly align with the actual temperature(s) within the system. Temperature probe readings may lag and thus not properly show changes in temperature in the various components of the system. This procedure may be beneficial when using simpler inexpensive heating or cooling elements in various parts of the system that require regulation of temperature.

The microcontroller may also control backfilling of the system with an inert gas upon completion of or during processing so as to prevent oxidation of fractions collected or any part of the composition of matter remaining in the evacuation chamber.

### Minimizing Oxidation of Target Compounds

For extractions where target compounds may be susceptible to oxidation, such as for the extraction of cannabinoids and terpenes from cannabis or hemp plant material, an inert atmosphere may be used to reduce the partial pressure of oxygen in the vapor stream. This may be achieved by evacuating or flushing the air from the system using argon, helium, nitrogen, or carbon dioxide. Once a suitably high vacuum is obtained, an inert gas such as nitrogen or argon may be streamed back into the system. As the pressure in the system rises, the streaming of the inert gas is stopped and the system is re-evacuated and the cycle is repeated. An inert gas may also be leaked into the system to act as a carrier gas so as to direct the vapor stream toward the condensers.

The inert gas reduces the oxidization of target compounds such as cannabinoids and may also improve quality of the target compounds.

Additional process gases may also be added to the system to chemically treat the target compounds as they are extracted. For example, a high partial pressure of CO₂ will reduce the proclivity of Δ-8-THC to decarboxylate. Since decarboxylated Δ-9-THC is psychoactive, this system may be used to prevent the psycho-activation of THC.

The system may be fully enclosed in an outside chamber or clean room that contains an inert gas, such that leaks in the system will be filled by the inert gas within the chamber or clean room.

### Insulation

The system may optionally be fully or partially enclosed in an insulating blanket that minimizes environmental heat loss or gain and provides a safety barrier for a user thereof.

### Illustrative Examples

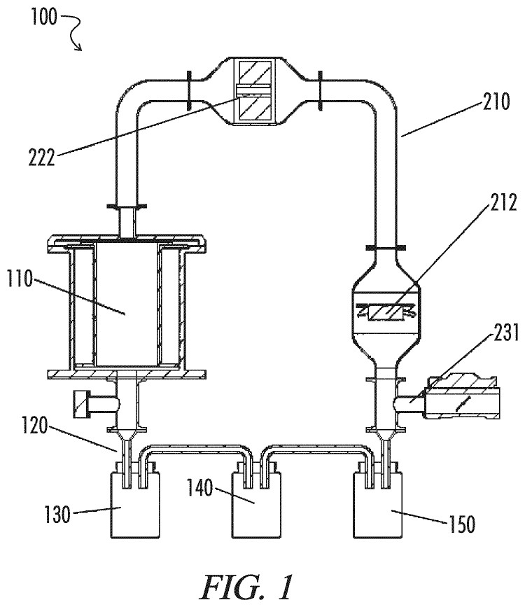

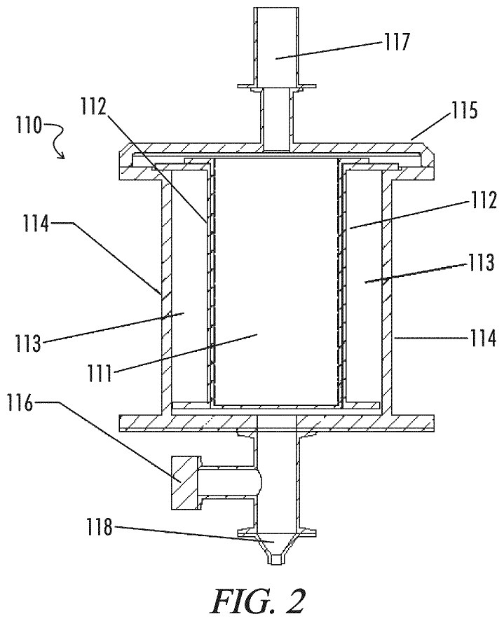

FIG. 1 shows a schematic representation of a first embodiment 100 of the disclosed system, and FIGS. 2-5 show exploded views of schematic representations of the components of the embodiment 100.

FIG. 1 shows a schematic representation of an embodiment 100 of the disclosed system that includes an evacuation chamber 110, a capture system 120 that includes condensers 130, 140, and 150, a recirculation system 210 that includes a blower 212 and a heat exchanger 222, and a vacuum inlet 231 which is connected to a vacuum pump (not shown).

FIG. 2 shows an exploded view of a schematic representation of the evacuation chamber 110 of the embodiment 100 shown in FIG. 1. The evacuation chamber 110 includes a product holding chamber 111 and heating elements 112 encased within an outer shell 114 and sealed with a lid 115. A pressure sensor port 116 is also included. An inlet 117 that allows a circulating vapor stream to enter the evacuation chamber from the recirculation system and an outlet 118 that directs the vapor stream toward the capture system are also depicted.

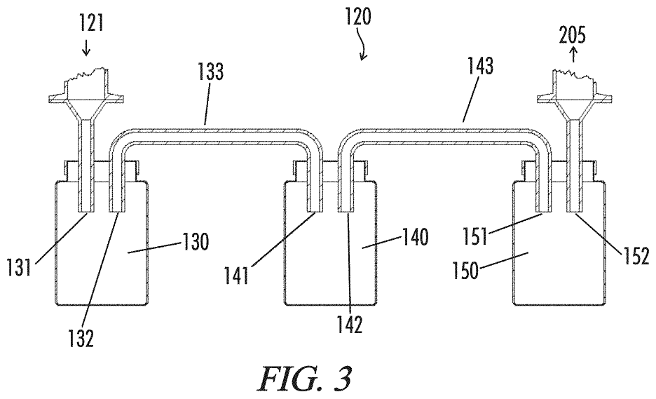

FIG. 3 shows an exploded view of a schematic representation of the capture system 120 of the embodiment 100 shown in FIG. 1, including condensers 130, 140, and 150. The vapor stream 121 enters the capture system 120 from the evacuation chamber 110 via an inlet. The vapor stream includes a carrier gas that is saturated or substantially saturated with target compounds. The primary condenser 130 includes an inlet valve 131 and an outlet valve 132 to regulate the flow of the vapor stream into and out of the primary condenser 130. When the outlet valve 132 is open, the vapor stream exits the primary condenser 130 via duct 133 and flows toward the secondary condenser 140. The secondary condenser 140 also includes an inlet valve 141 and an outlet valve 142 to regulate the flow of the vapor stream. When the outlet valve 142 is open, the vapor stream exits the secondary condenser 140 via duct 143 and flows toward the tertiary condenser 150. The tertiary condenser 150 also includes an inlet valve 151 and an outlet valve 152 to regulate the flow of the vapor stream. When the outlet valve 152 is open, the vapor stream exits the tertiary condenser 150 via an outlet and flows into the recirculation system as an unsaturated vapor stream 205. The unsaturated vapor stream 205 includes the carrier gas and may also include residual target compounds.

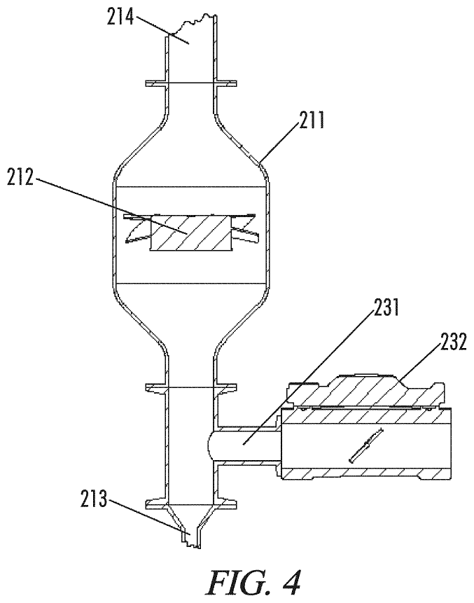

FIG. 4 shows an exploded view of a schematic representation of a blower chamber 211 that forms part of the recirculation system 210 of the embodiment 100 shown in FIG. 1. The blower chamber 211 houses a blower 212. The unsaturated vapor stream enters the blower chamber 211 via inlet 213 and exits the blower chamber at a higher flow rate via outlet 214. Vacuum inlet 231 is connected to a vacuum pump (not shown), and a valve 232 allows toggling of the vacuum within the system to further control the vapor stream as desired.

Embodiment 100 shows the blower chamber positioned such that the unsaturated vapor stream enters the blower chamber after it exits the cooling chamber. In alternate embodiments, the blower chamber may be situated between the evacuation chamber and the capture system, such that one or more blowers in the blower chamber cause the saturated vapor stream that exits the evacuation chamber at a given flow rate to enter the capture system at a higher flow rate. Multiple blower chambers may also be used if and as appropriate for a given application.

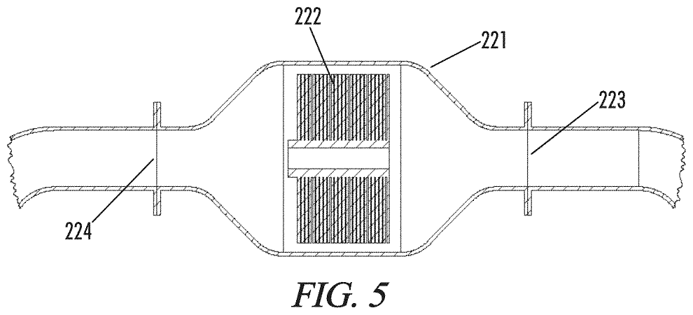

FIG. 5 shows an exploded view of a schematic representation of a heat exchange chamber 221 that forms part of the recirculation system 210 of the embodiment 100 shown in FIG. 1. The heat exchange chamber 221 houses a heat exchanger 222. Inlet 223 and outlet 224 valves control the flow of the vapor stream into and out of the heat exchange chamber. The heat exchanger 222 heats the unsaturated vapor stream prior to recirculation of the unsaturated vapor stream into the evacuation chamber 110.

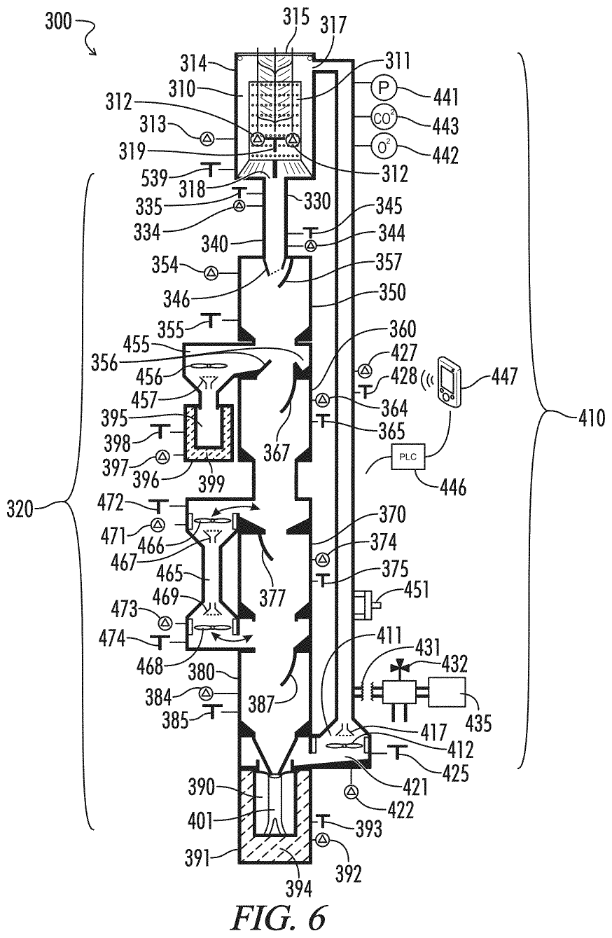

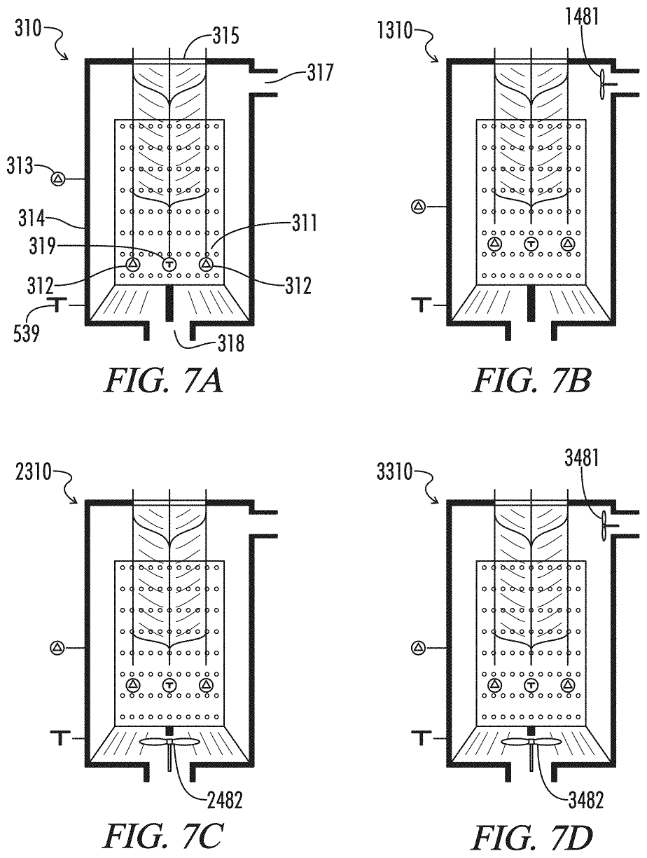

FIG. 6 shows a schematic representation of a second embodiment 300 of the disclosed system, and FIGS. 7-16 show exploded views of schematic representations of components of the embodiment 300 and alternate embodiments of various components.

FIG. 6 shows a schematic representation of an embodiment 300 of the disclosed system that includes an evacuation chamber 310, a capture system 320 that includes primary condensers 330 and 340 and secondary condensers 350, 360, 370, and 380, a recirculation system 410 that includes a blower 412 and a heat exchanger 422, and a vacuum inlet 431 which is connected to a vacuum pump 435.

The evacuation chamber 310 includes a product holding chamber 311 and heating elements 312 encased within an outer shell 314 and sealed with a lid 315. The temperature of the outer shell 314 is controlled as necessary using a heat exchanger 313. An inlet 317 that allows a circulating vapor stream to enter the evacuation chamber from the recirculation system and an outlet 318 that directs the vapor stream toward the capture system are also depicted. Thermocouples 319 and 539 are used to measure temperature at various locations within the evacuation chamber 310.

The vapor stream enters the capture system 320 from the evacuation chamber 310 via an inlet. The vapor stream includes a carrier gas that is saturated or substantially saturated with target compounds. Primary condensers 330 and 340 are used to condense water and/or heavy oils from the vapor stream. A first heat exchanger 334 is used to control the temperature of the first primary condenser 330. A second heat exchanger 344 is used to control the temperature of the second primary condenser. Thermocouples 335 and 345 are used to measure the temperatures of the primary condensers 330 and 340 respectively. Compounds condensed by the primary condensers 330 and 340 will drip into a first product capture vessel 390 via a tapered outlet funnel 346.

After the vapor stream exits the tapered outlet funnel 346, it enters a first secondary condenser 350. The flow path of the vapor stream is perturbed by a flow director 357. This perturbs the vapor stream and directs the flow toward the cooled outer walls of the first secondary condenser 350, thereby enhancing efficiency of collection of compounds targeted for collection by the first secondary condenser 350. The temperature of the outer walls of the first secondary condenser is controlled using a heat exchanger 354, and a thermocouple 355 is used to measure the temperature.

After condensing on the walls of the first secondary condenser 350, the condensate drips downward into a collection channel 356, which then directs the condensate into a second product capture vessel 395. The second product capture vessel is enclosed within an outer housing 396. The temperature of the outer housing 396 is regulated using a heat exchanger 397 and monitored using a thermocouple 398. A heat transfer medium 399 such as a fluidized bed may optionally surround the second product capture vessel 395.

A substantial portion of the remaining vapor stream enters into a first secondary condenser recirculation chamber 455, which includes a blower 456 and a vapor flow diffusion cone 457 below the blower 456. The vapor flow diffusion cone 457 directs the vapor stream toward the product capture vessel 395. This causes increased circulation within the first secondary condenser 350 and thereby increases separation efficiency and collection of the desired condensates.

After the vapor stream exits the first secondary condenser 350 and/or the first secondary condenser recirculation chamber 455, it enters a second secondary condenser 360. The flow path of the vapor stream is perturbed by a flow director 367. This perturbs the vapor stream and directs the flow toward the cooled outer walls of the second secondary condenser 360, thereby enhancing efficiency of collection of compounds targeted for collection by the second secondary condenser 360. The temperature of the outer walls of the second secondary condenser is controlled using a heat exchanger 364, and a thermocouple 365 is used to measure the temperature. The second secondary condenser 360 may have a product capture vessel connected thereto (not shown), and may also optionally have a recirculation chamber connected thereto (not shown). Condensate that is condensed in the second secondary condenser 360 may be collected in the product capture vessel connected to the second secondary condenser via a similar setup and in a similar manner as the condensate condensed in the first secondary condenser is collected.

After the vapor stream exits the second secondary condenser 360, it enters a third secondary condenser 370. The flow path of the vapor stream is perturbed by a flow director 377. This perturbs the vapor stream and directs the flow toward the cooled outer walls of the third secondary condenser 370, thereby enhancing efficiency of collection of compounds targeted for collection by the third secondary condenser 370. The temperature of the outer walls of the third secondary condenser is controlled using a heat exchanger 374, and a thermocouple 375 is used to measure the temperature.

After the vapor stream exits the third secondary condenser 370, it enters a fourth secondary condenser 380. The flow path of the vapor stream is perturbed by a flow director 387. This perturbs the vapor stream and directs the flow toward the cooled outer walls of the fourth secondary condenser 380, thereby enhancing efficiency of collection of compounds targeted for collection by the fourth secondary condenser 380. The temperature of the outer walls of the fourth secondary condenser is controlled using a heat exchanger 384, and a thermocouple 385 is used to measure the temperature.

The tapered design of the outlet funnel 346 causes products collecting thereupon to be channeled toward the side of the outlet funnel 346 that is opposite the flow director 357, and thus products dripping from the outlet funnel 346 will for the most part not come into contact with the flow directors 357, 367, and 387. Flow director 377 also preferably does not extend into the path that products dripping from the outlet funnel 346 will take into the product capture vessel 390.

Heat exchangers 334, 344, 354, 364, 374, and 384 may be selected from known components used for heating and cooling. For example, one or more of the heat exchangers may be composed of a heating element, tubing that surrounds the condenser through which a heat exchange fluid flows, jacketing that surrounds the condenser, where the jacketing may be configured to allow a heat exchange fluid to flow therethrough or may include other heating and/or cooling elements, or any other component suitable for heating and/or cooling of a condenser.

The third and fourth secondary condensers 370 and 380 are connected by a third secondary condenser recirculation chamber 465, which includes blowers 466 and 468 at the top and bottom respectively and includes vapor flow diffusion cones 467 and 469 at the top and bottom respectively. This allows recirculation of the vapor stream between the third and fourth secondary condensers 370 and 380, and thereby increases collection efficiency of compounds targeted for collection in each of these secondary condensers. The temperature within the third secondary condenser recirculation chamber 465 is controlled using heat exchangers 471 and 473, and is monitored using thermocouples 472 and 474.

Compounds that drip into the first product capture vessel 390 will be directed through a vapor flow control tube 401 toward the bottom of the first product capture vessel 390. The first product capture vessel is enclosed within an outer housing 391. The temperature of the outer housing 391 is regulated using a heat exchanger 392 and monitored using a thermocouple 393. A heat transfer medium 394 such as a heat transfer fluid may optionally surround the second product capture vessel 390.

Upon exiting the fourth secondary condenser 380, the vapor stream will also enter the vapor flow control tube 401 and exit at the bottom of the first product capture vessel 390. The vapor stream will exit the first product capture vessel 390 and flow toward the recirculation system 410.

Immediately upon entering the recirculation system 410, the vapor stream flows into a heat exchange chamber 421 that houses a first recirculation system heat exchanger 422. Temperature within the heat exchange chamber 421 is monitored using a thermocouple 425. After passing through the heat exchange chamber 421, the vapor stream enters a blower chamber 411 that houses a blower 412 and a vapor flow diffusion cone 417.

The temperature within the recirculation system 410 is controlled by a second recirculation system heat exchanger 427 and is monitored using a thermocouple 428. A pressure sensor 441, an oxygen sensor 442, and a carbon dioxide sensor 443 are also connected to the recirculation system 410 to monitor the pressure, and oxygen and carbon dioxide levels therein, respectively. Alternate embodiments may include any other combination of sensors from among the pressure sensor 441, oxygen sensor 442, and carbon dioxide sensor 443 or no such sensors.

A valve 432 allows toggling of the vacuum within the system to further control the vapor stream as desired. The valve 432 is used to increase or decrease the pressure within the system as desired, or to purge the system and/or the vacuum pump 435 of any condensed products.

The recirculation system 410 also includes an inert gas entry port 451 through which an inert gas may be introduced into the system.

A microcontroller 446 is used to control parameters within the system such as the temperature of the various condensers, system pressure, and other parameters. The microcontroller 446 is connected to an external computing device 447 such as a smartphone, tablet, or laptop to control inputs and monitor outputs within the system.

FIG. 7A shows an exploded view of a schematic representation of the evacuation chamber 310 of the embodiment 300 shown in FIG. 6. The evacuation chamber 310 includes a product holding chamber 311 and heating elements 312 encased within an outer shell 314 and sealed with a lid 315. The temperature of the outer shell 314 is controlled as necessary using a heat exchanger 313. An inlet 317 that allows a circulating vapor stream to enter the evacuation chamber from the recirculation system and an outlet 318 that directs the vapor stream toward the capture system are also depicted. Thermocouples 319 and 539 are used to measure temperature at various locations within the evacuation chamber 310.

FIGS. 7B-7D show schematic representations of alternate embodiments 1310, 2310, and 3310 of the evacuation chamber shown in FIG. 7A with blowers 1481, 2482, 3481, and 3482 situated at various locations within the respective evacuation chambers to increase the circulation of gases.

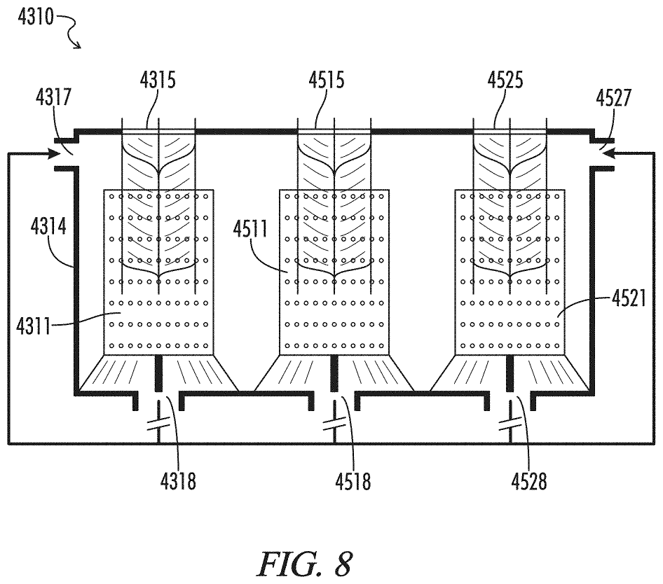

FIG. 8 shows a schematic representation of another alternate embodiment 4310 of the evacuation chamber with three product holding chambers 4311, 4511, and 4521 with corresponding lids 4315, 4515, and 4525 all enclosed within an outer shell 4314. The evacuation chamber 4310 is configured with multiple inlets 4317 and 4527 and multiple outlets 4318, 4518, and 4528 for optimal recirculation of gases. Heating elements and thermocouples (not shown) may also be situated at various locations to heat products placed within the product holding chambers and measure the temperature at various locations.

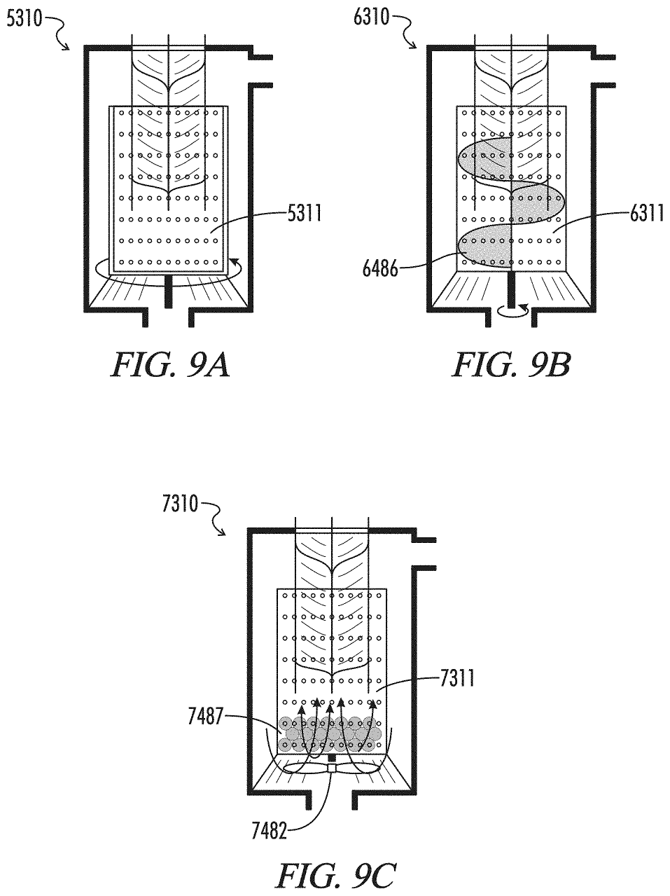

FIG. 9A shows a schematic representation of another alternate embodiment 5310 of the evacuation chamber with a rotating drum to assist with stirring of the product in the product holding chamber 5311.

FIG. 9B shows a schematic representation of another alternate embodiment 6310 of the evacuation chamber with a rotating auger 6486 to assist with stirring of the product in the product holding chamber 6311.

FIG. 9C shows a schematic representation of another alternate embodiment 7310 of the evacuation chamber with a fluidized bed 7487 and blower 7482 to assist with stirring of the product in the product holding chamber 7311.

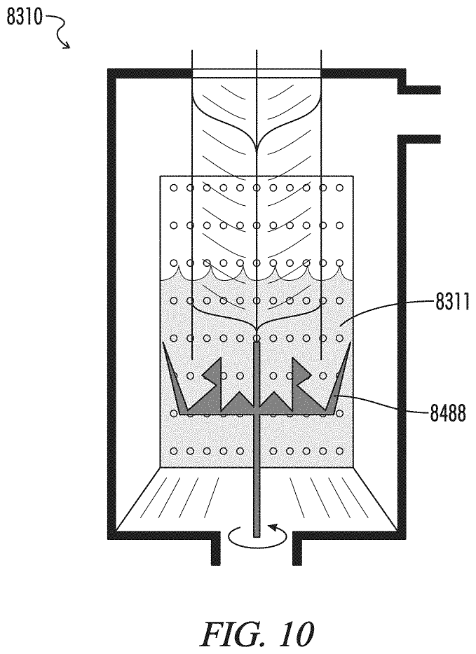

FIG. 10 shows a schematic representation of another alternate embodiment 8310 of the evacuation chamber with a lyser 8488 to assist with lysing of the product in the product holding chamber 8311. The lyser 8488 may be a grinder or series of cutting blades that may be rotated about a central axis.

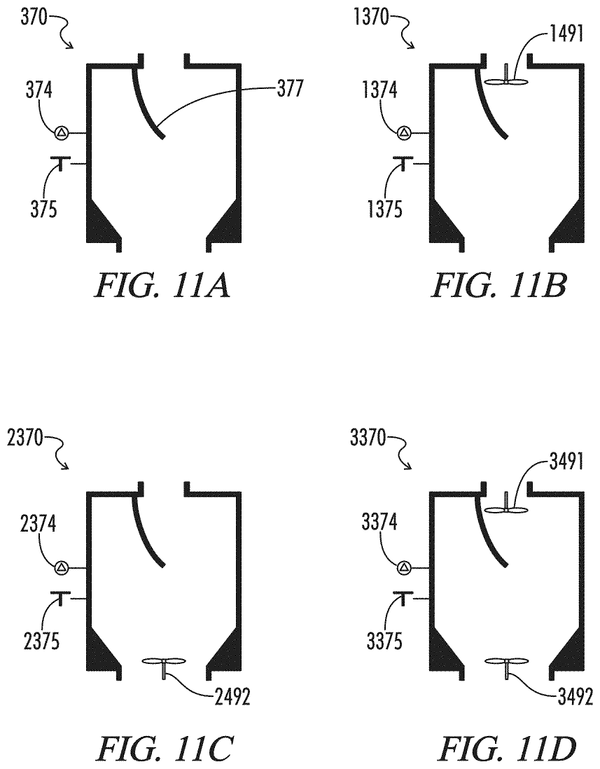

FIG. 11A shows an exploded view of a schematic representation of the third secondary condenser 370 of the embodiment 300 shown in FIG. 6. The flow path of the vapor stream entering the third secondary condenser 370 is perturbed by a flow director 377. This perturbs the vapor stream and directs the flow toward the cooled outer walls of the third secondary condenser 370, thereby enhancing efficiency of collection of compounds targeted for collection by the third secondary condenser 370. The temperature of the outer walls of the third secondary condenser is controlled using a heat exchanger 374, and a thermocouple 375 is used to measure the temperature.

FIGS. 11B-11D show schematic representations of alternate embodiments 1370, 2370, and 3370 of the condenser shown in FIG. 11A with blowers 1491, 2492, 3491, and 3492 situated at various locations within the respective condensers to increase the circulation of gases within and through the condensers, thereby enhancing the efficiency of product capture. The temperature of the outer walls of the condensers are controlled using heat exchangers 1374, 2374, and 3374 respectively, and thermocouples 1375, 2375, and 3375 respectively are used to measure the temperature. Similar alternate embodiments may be used in lieu of any or all of the secondary condensers 350 or 360.

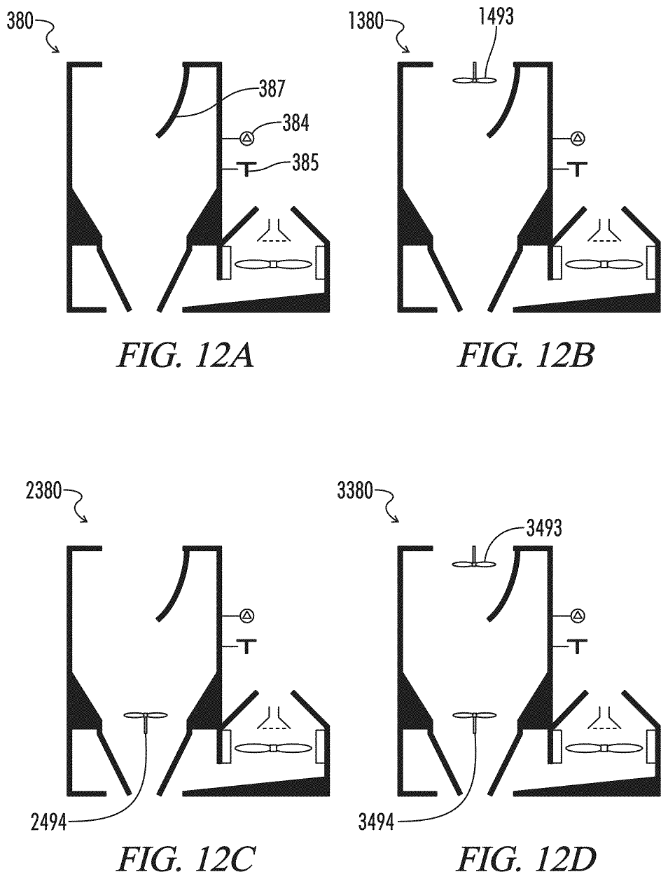

FIG. 12A shows an exploded view of a schematic representation of the fourth secondary condenser 380 of the embodiment 300 shown in FIG. 6. The flow path of the vapor stream is perturbed by a flow director 387. This perturbs the vapor stream and directs the flow toward the cooled outer walls of the fourth secondary condenser 380, thereby enhancing efficiency of collection of compounds targeted for collection by the fourth secondary condenser 380. The temperature of the outer walls of the fourth secondary condenser is controlled using a heat exchanger 384, and a thermocouple 385 is used to measure the temperature.

FIGS. 12B-12D show schematic representations of alternate embodiments 1380, 2380, and 3380 of the condenser shown in FIG. 11A with blowers 1493, 2494, 3493, and 3494 situated at various locations within the respective condensers to increase the circulation of gases within and through the condensers, thereby enhancing the efficiency of product capture.

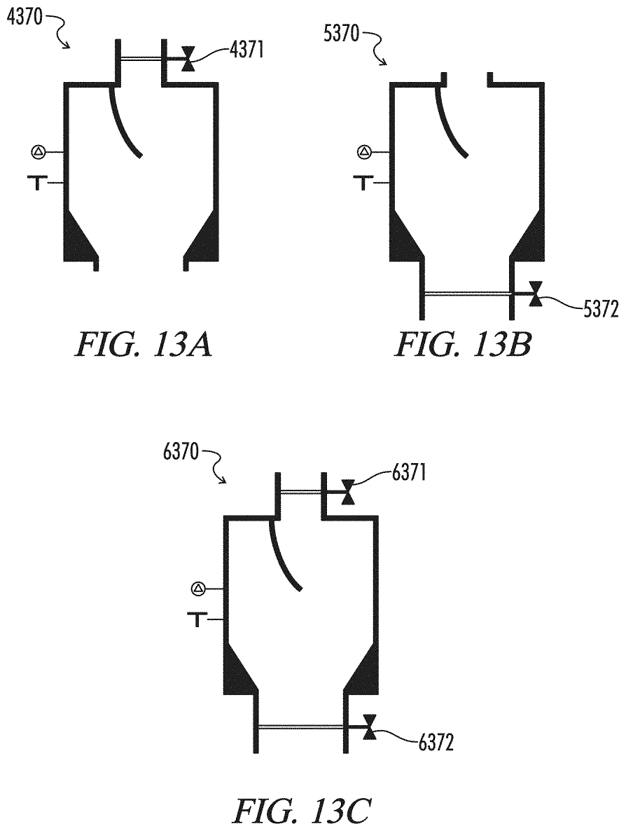

FIGS. 13A-13C show schematic representations of alternate embodiments 4370, 5370, and 6370 of the condenser shown in FIG. 11A with inlet valves 4371 and 6371 and outlet valves 5372 and 6372 to regulate the flow of the vapor stream into and/or out of the respective condensers. Similar alternate embodiments may be used in lieu of any or all of the secondary condensers of the embodiment 300 shown in FIG. 6.

In addition, the valve configurations shown in FIGS. 13A-13C may be combined with the blower configurations shown in FIGS. 11B-11D to generate additional configurations of condensers with both valves and blowers as desired.

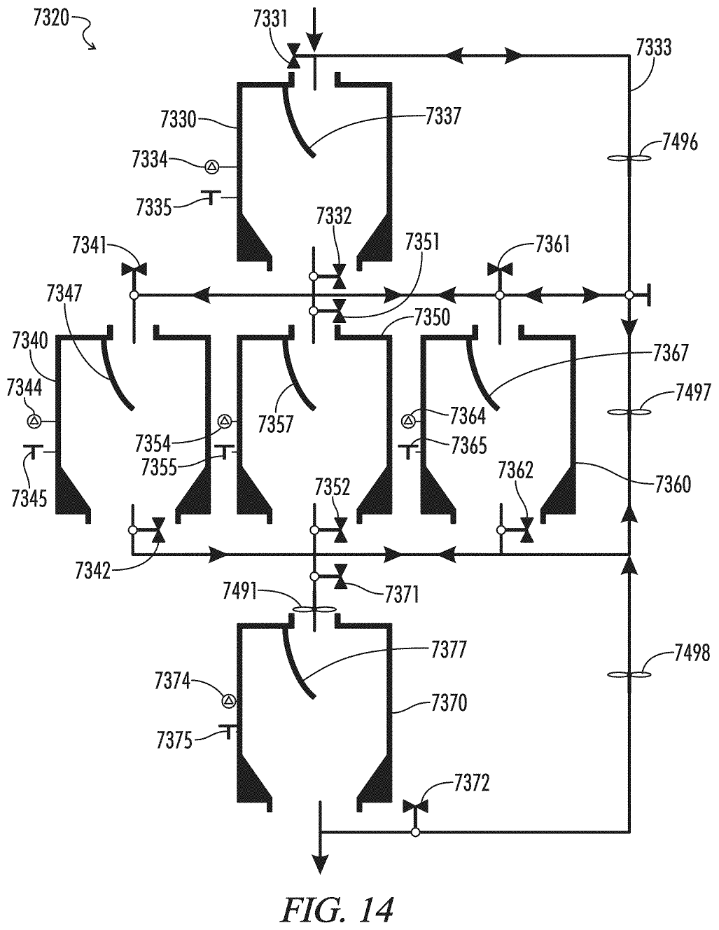

FIG. 14 shows a schematic representation of an embodiment of a capture system 7320 that includes an array of condensers 7330, 7340, 7350, 7360, and 7370 with corresponding flow directors 7337, 7347, 7357, 7367, and 7377, heat exchangers 7334, 7344, 7354, 7364, and 7374, and thermocouples 7335, 7345, 7355, 7365, and 7375. Product capture vessels are not shown for clarity. The capture system 7320 includes inlet valves 7331, 7341, 7351, 7361, and 7371 and outlet valves 7332, 7342, 7352, 7362, and 7372 for each condenser 7330, 7340, 7350, 7360, and 7370, respectively, to regulate the flow of gases within the capture system. The capture system also includes blower 7491 proximate to the inlet for condenser 7370 and blowers 7496, 7497, and 7498 at various points within the duct system 7333 that connects the condensers to each other. The duct system 7333 allows gases to be selectively circulated to desired condensers.

Alternate embodiments may include some or all of the configurational features of the capture system 7320 shown in FIG. 14, with more or fewer condensers, different arrangements of condensers, more or fewer blowers, more or fewer inlet and outlet valves, and including or excluding other features shown in other figures herein.

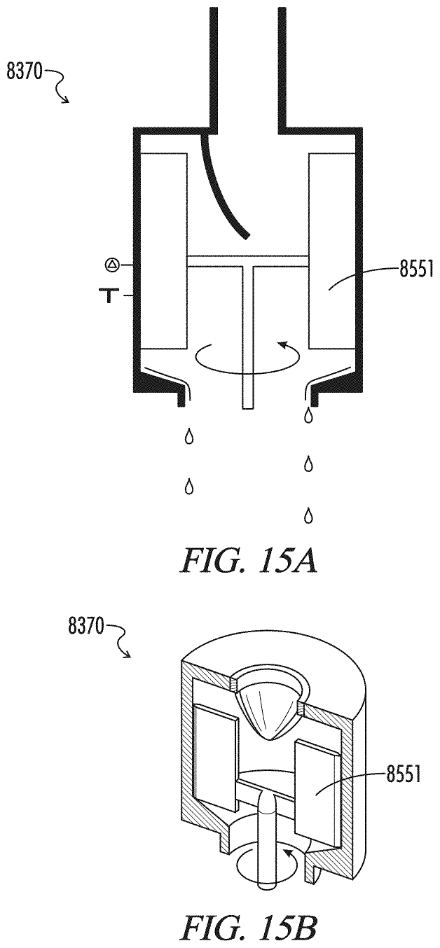

FIG. 15A shows a schematic representation of an alternate embodiment 8370 of the condenser shown in FIG. 11A with a wiper system 8551 that facilitates removal condensed products from the walls of the condenser 8370. The wiper system 8551 is configured to rotate around its central axis.

FIG. 15B shows a three-dimensional cutout view of the embodiment 8370 shown in FIG. 15A.

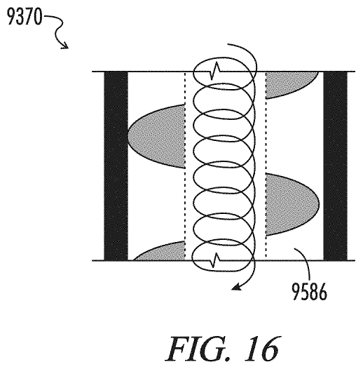

FIG. 16 shows a schematic representation of an alternate embodiment 9370 of the condenser shown in FIG. 11A with an auger-shaped flow path 9586 to increase circulation of gases within the condenser 9370.

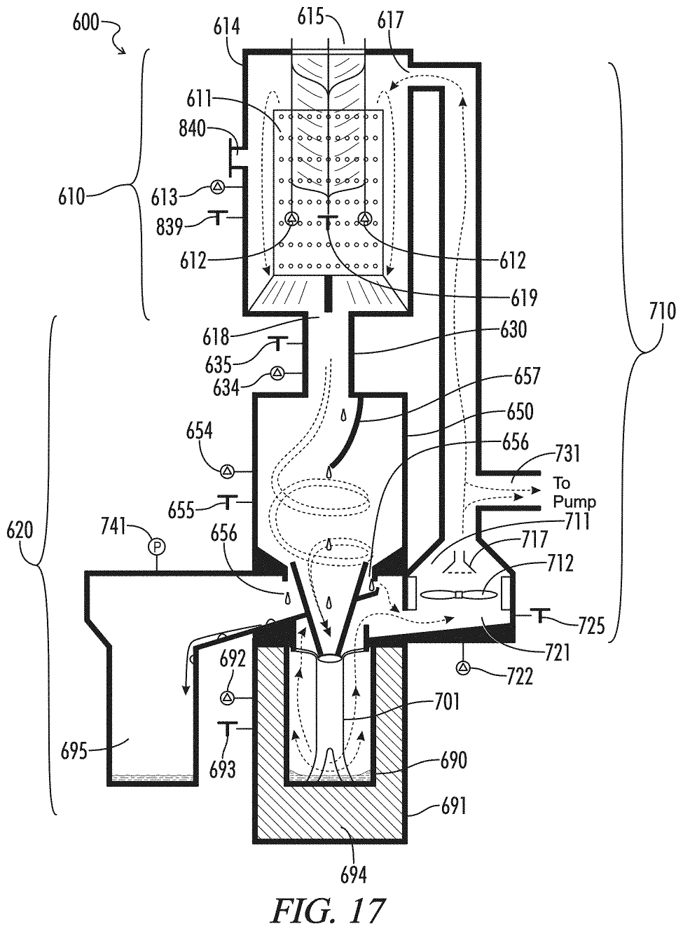

FIG. 17 shows a schematic representation of an embodiment 600 of the disclosed system that includes an evacuation chamber 610, a capture system 620 that includes a primary condenser 630 and a secondary condenser 650, a recirculation system 710 that includes a blower 712 and a heat exchanger 722, and a vacuum inlet 731 which is connected to a vacuum pump (not shown).

The evacuation chamber 610 includes a product holding chamber 611 and heating elements 612 encased within an outer shell 614 and sealed with a lid 615. The temperature of the outer shell 614 is controlled as necessary using a heat exchanger 613. An inlet 617 that allows a circulating vapor stream to enter the evacuation chamber from the recirculation system and an outlet 618 that directs the vapor stream toward the capture system are also depicted. Thermocouples 619 and 839 are used to measure the temperature at various locations within the evacuation chamber 610. Port 840 may be used to connect additional components, such as a second recirculation system inlet port, sensors such as a pressure sensor, oxygen sensor, or carbon dioxide sensor, or other optional components. Alternatively, port 840 may be sealed as shown in FIG. 17.

The vapor stream enters the capture system 620 from the evacuation chamber 610 via an inlet. The vapor stream includes a carrier gas that is saturated or substantially saturated with target compounds. A primary condenser 630 is used to condense water and/or heavy oils from the vapor stream. A heat exchanger 634 is used to control the temperature of the primary condenser 630. A thermocouple 635 is used to measure the temperature of the primary condenser 630. Compounds condensed by the primary condenser 630 will drip into a first product capture vessel 690.

After the vapor stream exits the primary condenser 630, it enters a secondary condenser 650. The flow path of the vapor stream is perturbed by a flow director 657. This perturbs the vapor stream and directs the flow toward the cooled walls of the secondary condenser 650, thereby enhancing efficiency of collection of compounds targeted for collection by the secondary condenser 650. The temperature of the outer walls of the secondary condenser is controlled using a heat exchanger 654, and a thermocouple 655 is used to measure the temperature. Compounds collecting on the walls of the secondary condenser 650 may be in various physical states, depending on the temperature and pressure within the system. Where the compounds are in the form of a condensate, the condensate drips downward into a collection channel 656, which then directs the condensate into a second product capture vessel 695.

Compounds that drip into the first product capture vessel 690 will be directed through a vapor flow control tube 701 toward the bottom of the first product capture vessel 690. The first product capture vessel is enclosed within an outer housing 691. The temperature of the outer housing 691 is regulated using a heat exchanger 692 and monitored using a thermocouple 693. A heat transfer medium 694 such as a heat transfer fluid may optionally surround the first product capture vessel 690.

Upon exiting the secondary condenser 650, the vapor stream will also enter the vapor flow control tube 701 and exit proximate to the bottom of the first product capture vessel 690. The vapor stream will exit the first product capture vessel 690 and flow toward the recirculation system 710.

Immediately upon entering the recirculation system 710, the vapor stream flows into a heat exchange chamber 721 that houses a recirculation system heat exchanger 722. Temperature within the heat exchange chamber 721 is monitored using a thermocouple 725. After passing through the heat exchange chamber 721, the vapor stream enters a blower chamber 711 that houses a blower 712 and a vapor flow diffusion cone 717.

A pressure sensor 741 is used to monitor the pressure within the system.

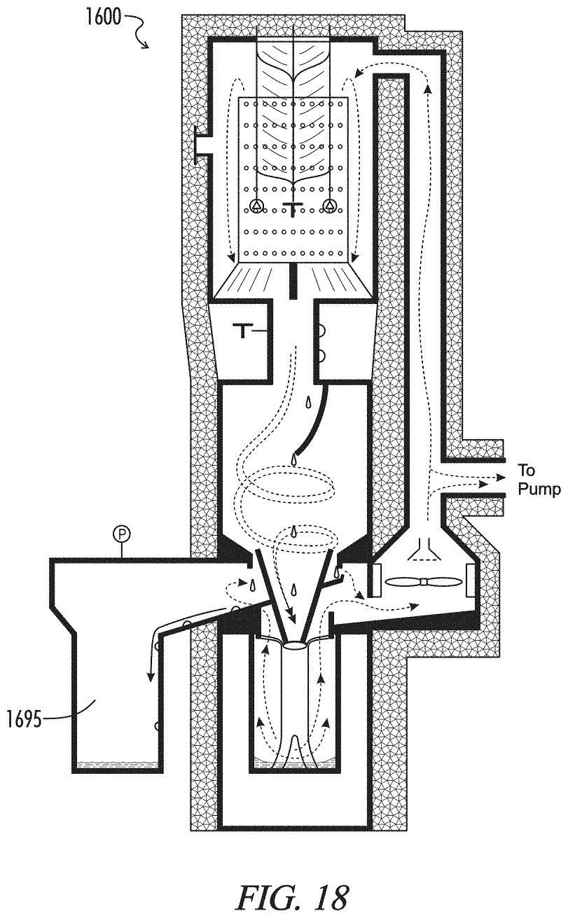

FIG. 18 shows an alternate embodiment 1600 of the embodiment 600 shown in FIG. 17 that has insulation surrounding all parts of the system except the second product capture vessel 1695. Components that are identical to the corresponding components in the embodiment 600 are not labeled for clarity. Some of the heat exchangers and thermocouples are not shown for clarity.

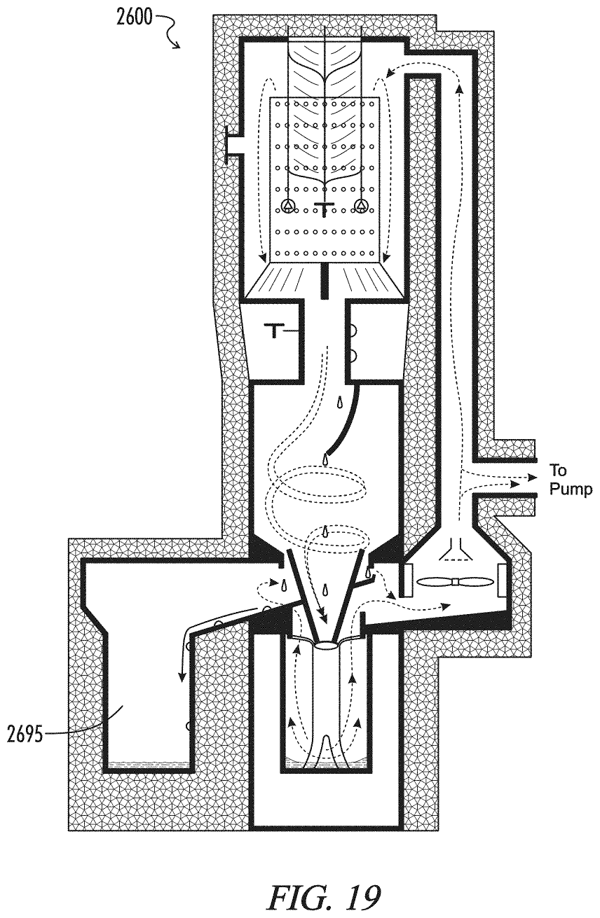

FIG. 19 shows an alternate embodiment 2600 of the embodiment 600 shown in FIG. 17 that has insulation surrounding all parts of the system, including the second product capture vessel 2695. Components that are identical to the corresponding components in the embodiment 600 are not labeled for clarity. Some of the heat exchangers and thermocouples are not shown for clarity.

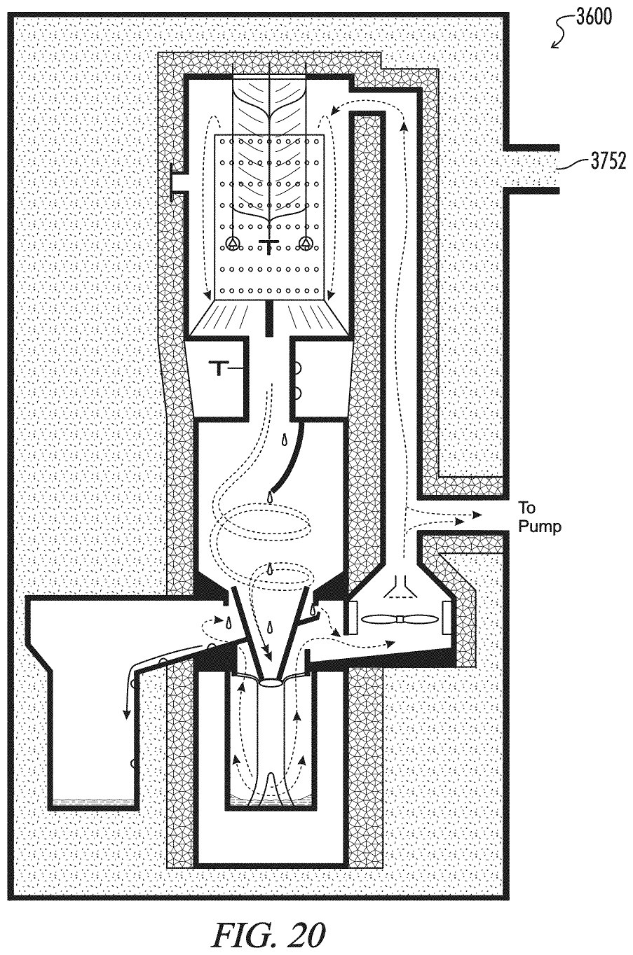

FIG. 20 shows an alternate embodiment 3600 of the embodiment 1600 shown in FIG. 18 that has an outer enclosure that is connected to an inert gas port 3752 such that the entire system may be held under an inert atmosphere.

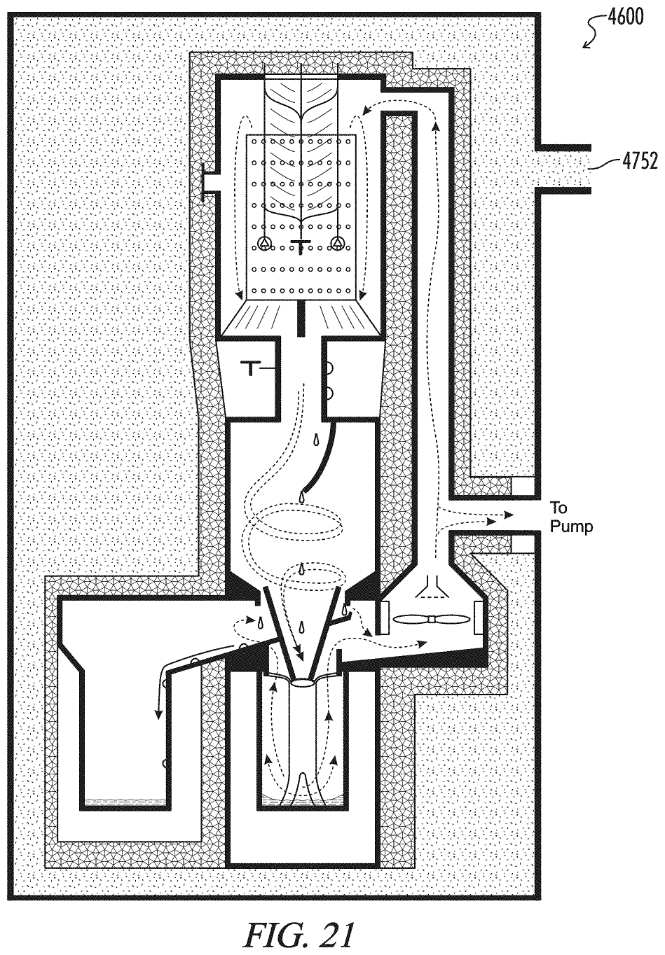

FIG. 21 shows an alternate embodiment 4600 of the embodiment 2600 shown in FIG. 19 that has an outer enclosure that is connected to an inert gas port 4752 such that the entire system may be held under an inert atmosphere.

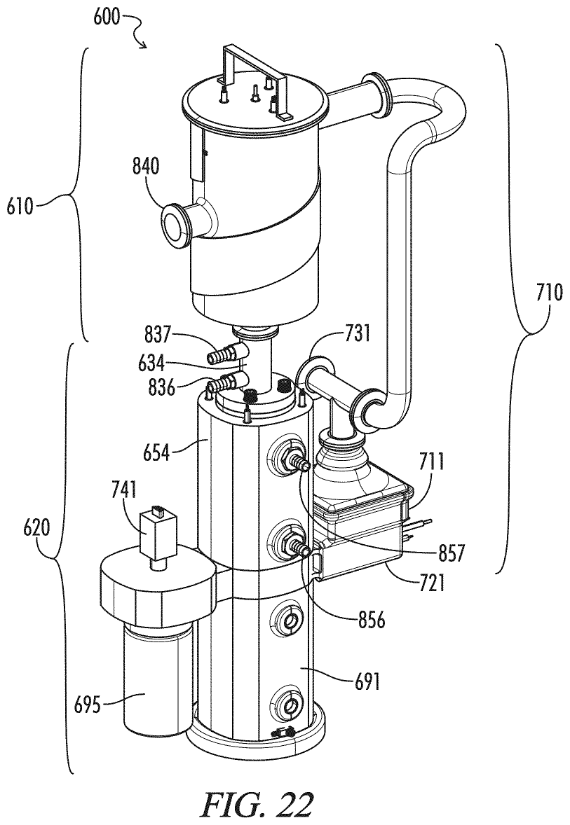

FIG. 22 shows a three-dimensional representation of the embodiment 600 shown in FIG. 17, including the evacuation chamber 610, the capture system 620, and the recirculation system 710. The heat exchangers 634 and 654 associated with the primary and secondary condensers, respectively, are jackets that surround the respective condensers (not shown). A heat exchange fluid is circulated through an inlet port 836 and an outlet port 837 of the heat exchanger 634 when the primary condenser is in operation. A heat exchange fluid is circulated through an inlet port 856 and an outlet port 857 of the heat exchanger 654 when the secondary condenser is in operation. The first product capture vessel (not shown) is enclosed within an outer housing 691. The second product capture vessel 695 is not enclosed within an analogous outer housing. The heat exchange chamber 721 and blower chamber 711 house the heat exchanger (not shown) and blower (not shown) of the recirculation system, respectively. The port 840 is sealed using an appropriate blank-off flange. The vacuum pump (not shown) is connected to the system via the vacuum inlet 731. The pressure sensor 741 is used to monitor the pressure within the system.

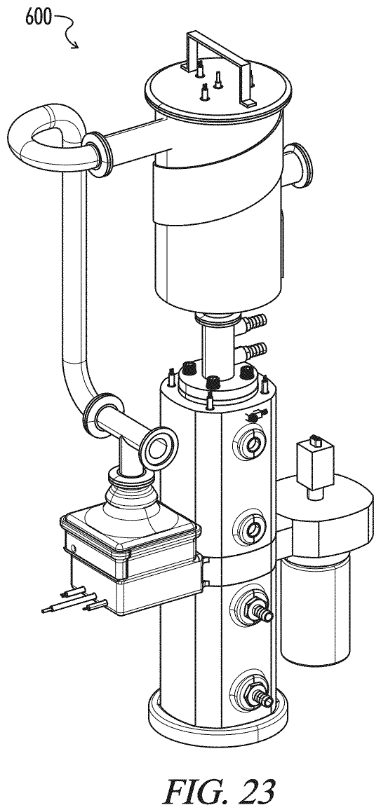

FIG. 23 shows an opposing view of the three-dimensional representation of the embodiment 600 that is shown in FIG. 22.

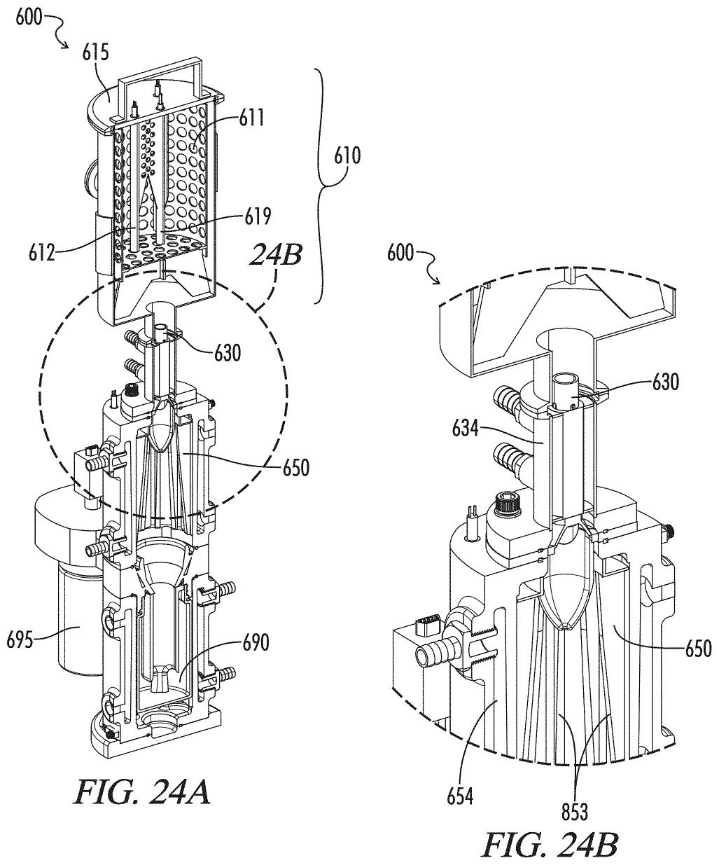

FIG. 24A shows a cross-sectional view of the three-dimensional representation of the embodiment 600 shown in FIGS. 22-23. The recirculation system is not shown for clarity. The heating elements 612 and thermocouple 619 extend downward from and are connected to the lid 615 that seals the evacuation chamber 610. The heating elements 612 and thermocouple 619 extend sufficiently close to the bottom of the product holding chamber 611 so as to be in direct contact with plant matter that is placed within the product holding chamber. In alternate embodiments, the depth to which the heating elements 612 and thermocouple 619 extend may be varied.

The primary condenser 630 and secondary condenser 650 are situated within the heat exchangers 634 and 654, respectively, used to cool—or heat, as necessary—the condensers. Products captured in the primary condenser 630 are collected in the first product capture vessel 690, and products captured in the secondary condenser 650 are collected in the second product capture vessel 695.

FIG. 24B shows an exploded view of a part of the cross-sectional view shown in FIG. 24A, showing the primary condenser 630 and the upper part of the secondary condenser 650 and the corresponding heat exchangers 634 and 654. Collection channels 853 are built into the walls of the secondary condenser 650 to facilitate collection of products.

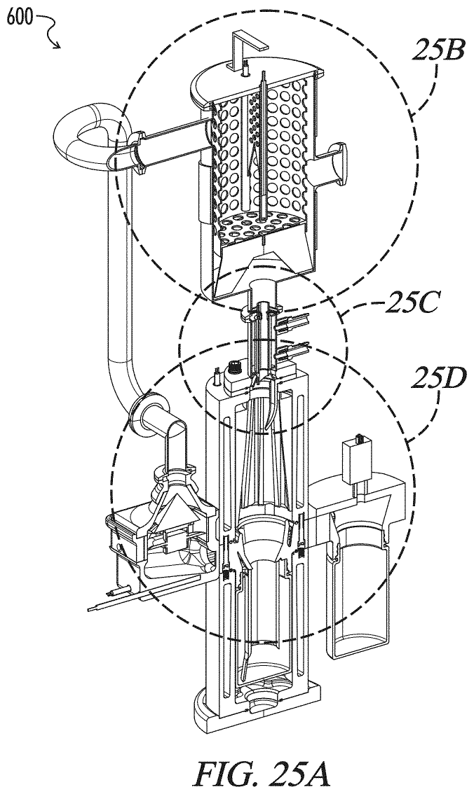

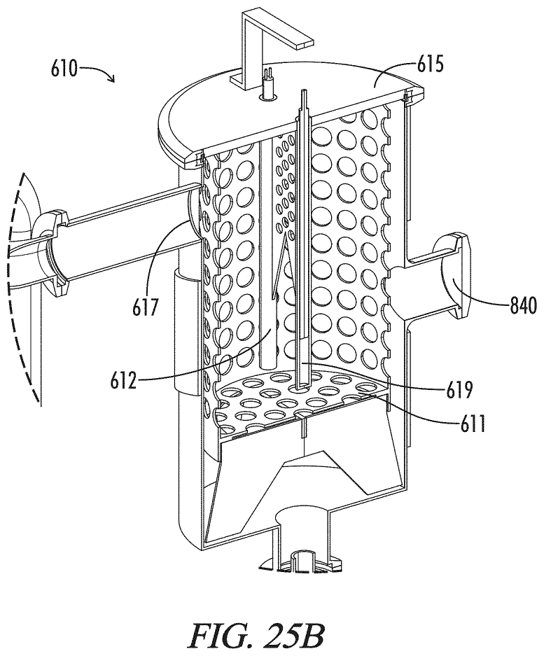

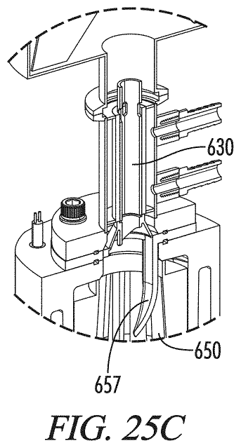

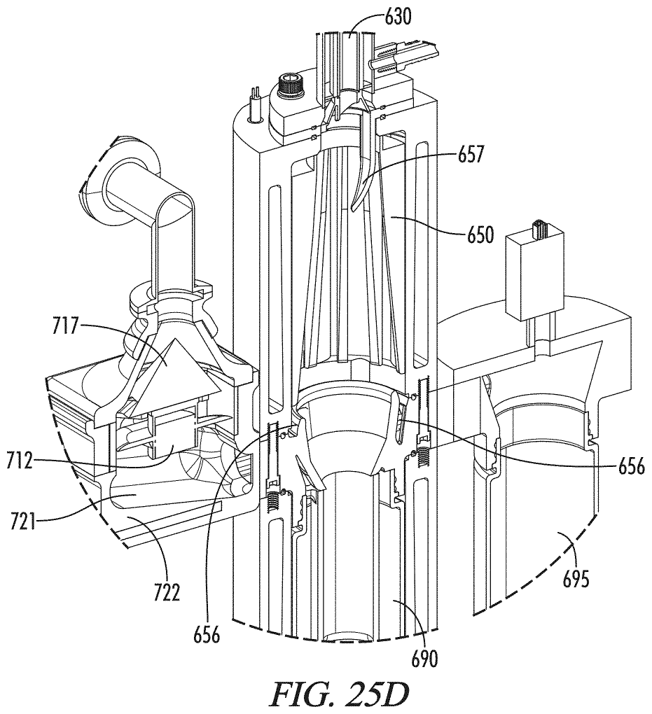

FIG. 25A shows another cross-sectional view of the three-dimensional representation of the embodiment 600 shown in FIGS. 22-23.

FIG. 25B shows an exploded view of a part of the cross-sectional view shown in FIG. 25A, where the exploded view shows the evacuation chamber 610. The exploded view shows how the thermocouple 619 is connected to the heating element 612 within the product holding chamber 611. Two additional heating elements within the product holding chamber 611 are not shown. The thermocouple 619 and heating element 612 are also both separately connected to the lid 615. The inlet 617 that connects the evacuation chamber 610 to the recirculation system and the sealed port 840 are also shown.

FIG. 25C shows an exploded view of a part of the cross-sectional view shown in FIG. 25A, where the exploded view shows a cross-sectional view of the primary condenser 630 and the upper part of the secondary condenser 650. The flow director 657 extends from the interface between the primary condenser 630 and the secondary condenser 650 into the upper part of the secondary condenser 650.

FIG. 25D shows an exploded view of a part of the cross-sectional view shown in FIG. 25A, where the exploded view shows a cross-sectional view of the secondary condenser 650, the lower parts of the primary condenser 630 and the recirculation system 710, and upper parts of the first product capture vessel 690 and the second product capture vessel 695.

The flow director 657 extends from the interface between the primary condenser 630 and the secondary condenser 650 into the upper part of the secondary condenser 650.

The recirculation system heat exchanger 722 is a heated surface within the heat exchange chamber 721. The surface of the recirculation system heat exchanger 722 is angled to facilitate flow of products that may be liquified thereon to flow into the first product capture vessel 690. This promotes recapture of products that may have solidified on the surface of the recirculation system heat exchanger 722. The blower 712 is situated below the vapor flow diffusion cone 717, such that the blower 712 facilitates transport of the remaining vapor stream through the vapor flow diffusion cone 717 and into the upper part of the recirculation system.

### Methods of Capturing Products

Methods of direct extraction from compositions of matter are also disclosed herein. Although the methods will be further described below in terms of particular general steps, it should be understood that the methods may use any embodiment of the disclosed systems for direct extraction from compositions of matter to extract target compounds. Thus, even if a particular feature, component, or embodiment of the disclosed systems is not specifically described for use in any specific embodiments of the disclosed methods, it is nonetheless intended to be understood that such a feature, component, or embodiment may be used in the disclosed methods.

The methods may include the following steps in order:
(1) introducing a composition of matter that includes one or more target compounds into an evacuation chamber;
(2) reducing the pressure within the evacuation chamber using a vacuum system to extract one or more of the target compounds from the composition of matter and thereby yield one or more vapor phase target compounds contained within an unprocessed vapor stream;
(3) transferring the unprocessed vapor stream from the evacuation chamber into a capture system;
(4) condensing one or more of the vapor phase target compounds in one or more stages to yield one or more sets of condensed target compounds and a processed vapor stream;
(5) transferring the processed vapor stream from the capture system into the evacuation chamber.
   The one or more condensation stages may be used to separate target compounds into as many groups as desired. Thus, for example, the disclosed methods may use a system that has several condensation stages such as the embodiment shown in FIG. 6. Alternatively, the disclosed methods may use a system that has only two main condensation stages such as the embodiment shown in FIG. 17. Any of the configurations or sub-configurations of the embodiments shown in FIGS. 1-25, including configurations that use features shown in multiple figures, may be used in the disclosed methods. Other configurations not shown that are based on the embodiments shown in FIGS. 1-25 or otherwise include or are consistent with the components and features of the disclosed systems described herein may also be used in the disclosed methods.

In some embodiments, the composition of matter used in the disclosed methods is plant matter. The plant matter may be raw plant matter that is unprocessed, or may alternatively be partially processed prior to extraction using the disclosed methods.

In some embodiments, the plant matter is mechanically lysed prior to introduction into the evacuation chamber, or alternately after it is introduced into the evacuation chamber, as described in more detail above. The mechanical lysing may occur prior to reduction of pressure within the evacuation chamber, or may alternately occur after the pressure within the evacuation chamber has been reduced.

In some embodiments, the plant matter may be heated. This may be accomplished by directly heating the plant matter, by heating the housing of the evacuation chamber, or a combination thereof. Heating steps may be carried out before, during, or after reducing the pressure within the evacuation chamber.

In some embodiments, the capture system includes one or more condensers. In some embodiments, the capture system includes additional components, such as flow directors and temperature control and monitoring components, as described in more detail above.

In some embodiments, the capture system includes at least two condensers that are held at different temperatures for at least a part of the duration that the capture system is in use for extraction according to the disclosed methods. In some embodiments, the capture system includes at least two condensers that are aligned substantially vertically when the capture system is in use for extraction according to the disclosed methods.

In some embodiments, a recirculation system, such as the embodiments of the recirculation system described in more detail above, is used to transfer the processed vapor stream from the capture system to the evacuation chamber. In some embodiments, the capture system also includes recirculation components that recirculate vapors within the capture system, as described above.

### Advantages of Using Disclosed Systems and Methods

The disclosed systems and methods provide several advantages over known systems and methods for separating raw materials into component materials.

For example, typical short path distillation systems require a pressure differential to condense target compounds. By contrast, the disclosed systems and methods do not necessitate a significant pressure differential to separate target compounds or fractions.

In addition, the disclosed systems and methods do not require heating of the raw material for proper operation. Rather, the application of heat is optional, and whether applying heat is desirable using the disclosed systems and methods depends on the specific raw materials being processed.

In addition, the disclosed systems are capable of operation at a comparatively high system pressure as compared to typical short path distillation systems. This is because movement of a carrier gas is transporting the target compounds rather than purely diffusion coupled with a pressure differential. The process that transports the target compounds in the disclosed methods may be described as non-thermal convection or carrier gas induced circulation.

Because of the comparatively high system pressure, the disclosed systems will exhibit superior heat transfer as compared to systems with comparatively lower system pressures. This is because heat is more efficiently transferred at higher pressure due to the higher gas density.

Moreover, processing of raw materials with high water content is unproblematic using the disclosed systems. As even pre-dried plant matter often has significant water content, the disclosed systems allow processing of raw plant matter instead of plant oils. Since the processing of plant oils requires pre-extraction to generate the plant oils, use of the disclosed systems eliminates this step.

Short path distillation systems require relatively low system pressure for effective diffusion, as the diffusion rates of gases are reduced at higher pressure. This is because the increased gas density reduces the mean free path of gas molecules.

In addition, scale-up of short path distillation systems typically requires aggressive, and therefore expensive, vacuum pumping systems to achieve the required pressure gradients. The disclosed systems do not suffer from this same disadvantage.

The use of a blower within a system that is operating at pressures below atmospheric pressure allows rapid and economical transport of comparatively high quantities of both water vapor and target compounds. Thus the disclosed systems are both highly efficient and economical for use in processing large quantities of plant matter.

### Terminology

In the description of various components of the disclosed systems and various steps of the disclosed methods that are described above, it is to be understood that the composition of matter may be raw plant matter, partially processed plant matter, or any other composition of matter suitable for use in the disclosed systems and methods, regardless of whether a specific reference is made to plant matter or another suitable composition of matter when describing the specific embodiments of the disclosed systems and methods being discussed. As such, where a specific component or embodiment is described only with respect to extraction of target compounds from compositions of matter, it is to be understood that the component or embodiment may be used with systems or methods for direct extraction of target compounds from plant matter. Similarly, where a specific component or embodiment is described only with respect to extraction of target compounds from plant matter, it is to be understood that the component or embodiment may be used with systems or methods for direct extraction of target compounds from other compositions of matter.

In addition, while the direct extraction systems and methods described above have been described in the context of extraction of target compounds from compositions of matter, it should be understood and appreciated that the systems and methods may also be used to extract chemical species that are not distinct compounds from compositions of matter. Thus, for example, in some embodiments the chemical species extracted may be elements, ions, or other chemical species that are not encompassed by the term compound as understood by ordinary skilled artisans.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Further, any range of numbers recited above describing or claiming various aspects of the invention, such as ranges that represent a particular set of properties, units of measure, conditions, physical states, or percentages, is intended to literally incorporate any number falling within such range, including any subset of numbers or ranges subsumed within any range so recited. The terms “about” and “approximately” when used as modifiers are intended to convey that the numbers and ranges disclosed herein may be flexible as understood by ordinarily skilled artisans and that practice of the disclosed invention by ordinarily skilled artisans using properties that are outside of a literal range will achieve the desired result.

Each of the foregoing and various aspects, together with those summarized above or otherwise disclosed herein, including the figures, may be combined without limitation to form claims for a device, apparatus, system, method of manufacture, and/or method of use.

All references cited herein are hereby expressly incorporated by reference.

What is claimed is:

1. A method of direct extraction from a composition of matter comprising the following steps in order:
a. introducing a composition of matter that includes one or more target compounds into an evacuation chamber;
b. reducing the pressure within the evacuation chamber using a vacuum system to extract one or more of the target compounds from the composition of matter and thereby yield one or more vapor phase target compounds contained within an unprocessed vapor stream;
c. transferring the unprocessed vapor stream from the evacuation chamber into a capture system;
d. condensing one or more of the vapor phase target compounds in one or more stages to yield one or more sets of condensed target compounds and a processed vapor stream; and
e. transferring the processed vapor stream from the capture system to the evacuation chamber.

2. The method of claim 1, wherein the composition of matter is plant matter.

3. The method of claim 2 wherein the plant matter is unprocessed plant matter.

4. The method of claim 2, wherein the plant matter is mechanically lysed prior to introduction into the evacuation chamber.

5. The method of claim 2 further comprising mechanically lysing the plant matter in the evacuation chamber before reducing the pressure within the evacuation chamber.

6. The method of claim 2 further comprising heating at least a part of the evacuation chamber before reducing the pressure within the evacuation chamber.

7. The method of claim 2 further comprising using a recirculation system to transfer the processed vapor stream from the capture system to the evacuation chamber.

8. The method of claim 7, wherein the recirculation system comprises one or more blowers.

9. The method of claim 8, wherein the one or more blowers are housed within one or more blower chambers.

10. The method of claim 2, wherein the capture system comprises one or more condensers.

11. The method of claim 7, wherein the capture system comprises one or more condensers.

12. The method of claim 8, wherein the capture system comprises one or more condensers.

13. The method of claim 10, wherein the capture system includes one or more flow directors.

14. The method of claim 10, wherein the capture system includes one or more blowers.

15. The method of claim 13, wherein the capture system includes one or more blowers.

16. The method of claim 10, wherein the capture system includes at least two condensers and wherein at least two condensers are held at different temperatures.

17. The method of claim 10, wherein the capture system includes at least two condensers that are aligned substantially vertically when the capture system is in use.

18. A system for direct extraction from a composition of matter comprising:
a. an evacuation chamber;
b. a capture system that is operationally connected to the evacuation chamber and is positioned below the evacuation chamber when the system is in use;
c. a recirculation system comprising at least one blower that is operationally connected to both the capture system and the evacuation chamber; and
d. a vacuum pump;
wherein the recirculation system is configured to transport a vapor stream from the capture system to the evacuation chamber.

19. The system of claim Error! Reference source not found, wherein the capture system includes at least one blower.

20. The system of claim 18 wherein the capture system includes at least one flow director.
